(19) United States
(12) Patent Application Publication
(10) Pub. No.: US 2006/0253324 A1
(43) Pub. Date: Nov. 9, 2006

(54) Systems and methods for combining subscription services, rewards programs, and sweepstakes

(75) Inventor: James G. Miller, Wellesley, MA (US)

Correspondence Address: WILMER CUTLER PICKERING HALE AND DORR LLP, 60 STATE STREET, BOSTON, MA, 02109, US

(73) Assignee: 1-800-JACKPOT, Wellesley, MA (US)

(21) Appl. No.: 11/404,373

(22) Filed: Apr. 14, 2006

Related U.S. Application Data
(60) Provisional application No. 60/671,848, filed on Apr. 15, 2005.
(60) Provisional application No. 60/677,965, filed on May 5, 2005.
(60) Provisional application No. 60/733,986, filed on Nov. 4, 2005.

(51) Int. Cl. G06Q 30/00

(52) U.S. Cl. 705/14

(57) ABSTRACT

A method includes, in response to a request by a subscriber for a subscription to a product or service, wherein the subscription has a subscription period and wherein the subscription period is initially for a first period of time, automatically providing the subscriber with the product or service for the first period of time. The method also includes automatically entering the subscriber into one or more sweepstakes drawings which occur during the first period of time. The one or more sweepstakes drawings have one or more corresponding jackpots. The method also includes, at the end of the subscription period, automatically renewing the subscription for a next period of time; and in connection with the renewed subscription, automatically entering the subscriber into one or more sweepstakes drawings which occur during the next period of time. The operations of automatic renewing the subscription for a next period of time, and automatically entering the subscriber into one or more sweepstakes drawings occurring during that period of time are repeated until the subscriber terminates the subscription.

### RELATED APPLICATIONS

This application claims the benefit of U.S. Provisional Application No. 60/671,848, filed Apr. 15, 2005, U.S. Provisional Application No. 60/677,965, filed May 5, 2005, and U.S. Provisional Application No. 60/733,986, filed Nov. 4, 2005, the contents of which are incorporated herein by reference.

### TECHNICAL FIELD

This invention generally relates to subscription services, rewards programs, and sweepstakes.

### BACKGROUND OF THE INVENTION

Some companies use coupons to attempt to persuade consumers to purchase a product or service. In 2003, approximately 258 billion coupons were distributed in the United States, making it a popular means of rewarding customers. In 2004, 96 billion pieces of direct mail were sent, at a cost of over $49 billion. Internet coupons represent a growing category of the coupon market, although advertising on the Internet has become increasingly expensive, particularly for high traffic websites such as AOL, MSN, Google, and Yahoo. Because of the large advertising expense, the growth of Internet coupons has been limited almost exclusively to large corporations with large media budgets. As a result, the Internet accounts for just one-half of one percent (0.5%) of the total coupon market.

Some companies use sweepstakes to promote their products and to reward customer loyalty. Although sweepstakes are useful marketing tools, the cost of running a sweepstakes, particularly a sweepstakes that offers attractive prizes, is prohibitively expensive for many companies.

### SUMMARY OF THE INVENTION

A Subscription to a Rewards Program automatically renews, and automatically enters Subscribers for free in multiple Sweepstakes for as long as the Subscriber maintains his Subscription. The Rewards Program offers a vast array of rewards, benefits, and special discounts that are updated three times a week to meet the ever-changing needs and desires of the Subscriber.

In general, in one aspect, a method includes, in response to a request by a subscriber for a subscription to a product or service, wherein the subscription has a subscription period and wherein the subscription period is initially for a first period of time, automatically providing the subscriber with the product or service for the first period of time. The method also includes automatically entering the subscriber into one or more sweepstakes drawings which occur during the first period of time. The one or more sweepstakes drawings have one or more corresponding jackpots. The method also includes, at the end of the subscription period, automatically renewing the subscription for a next period of time; and in connection with the renewed subscription, automatically entering the subscriber into one or more sweepstakes drawings which occur during the next period of time. The operations of automatic renewing the subscription for a next period of time, and automatically entering the subscriber into one or more sweepstakes drawings occurring during that period of time are repeated until the subscriber terminates the subscription.

Other embodiments include one or more of the following features. Receiving authorization from the subscriber to repeatedly automatically renew the subscription. Conditioning an eligibility of the Subscriber to be entered in the one or more sweepstakes drawings which occur during the subscription period on the repeated renewal of the subscription. Requiring the subscriber to pay for the subscription by way of an automatic payment method, such as one of a credit card, charge card, debit card, a charge to a phone bill, and an automatic withdrawal from a bank account.

Additional features and variations found in still other embodiments include the following. Setting the jackpot for at least one sweepstakes drawing above a predetermined minimum amount. If the at least one sweepstakes drawing fails to produce a winner, rolling the jackpot for that sweepstakes drawing into the jackpot for a consecutive sweepstakes drawing. Limiting the jackpot for the at least one sweepstakes drawing to be less than or equal to a predetermined maximum amount. If the jackpot for the at least one sweepstakes drawing reaches the predetermined maximum amount and that sweepstakes drawing fails to produce a winner, conducting a second drawing to determine one or more winners of said jackpot. The second drawing includes randomly selecting a number from 1-20 to determine the number of winners of the jackpot. Or, if a predetermined date is reached and the jackpot for the at least one sweepstakes drawing has not reached the predetermined maximum amount, conducting additional drawings until there is a winner of the jackpot. The sweepstakes drawing includes identifying multiple winning entries, treating these entries as finalists, and holding a second drawing to determine a single winner. The one or more sweepstakes drawings may select a corresponding winner using a random number generation mechanism. The random number generation mechanism may include a computerized random number generator.

Still more features and variations found in still other embodiments include the following. The product or service is a rewards program. Providing the subscriber with the product or service includes enrolling the subscriber in the rewards program. The rewards program includes at least one partner company offering at least one of a discount on an item or service, a benefit, or deal to the subscriber. The partner company is rewarded based on the value of the discount, benefit, or deal it provides to the subscriber, such as by providing the partner company with at least one of advertising space, priority placement at the top of search results, and free entry into one or more sweepstakes. The rewards program includes at least one of a newsletter, an online marketplace, an online shopping area, an online coupons area, and an instant rewards notification tool. The online marketplace includes classified ad listings. The subscriber is eligible to post a classified ad listing for free on the online marketplace. A classified ad listing of the subscriber receives priority placement related to a number of subscriptions the subscriber holds. The online shopping area includes discounted products or services offered for sale by at least one partner company. The newsletter is sent electronically to the subscriber. The newsletter contains an update to the rewards program. The newsletter contains a link to one or more online features of the rewards program. The online coupons area includes at least one of a printable coupon to a brick and mortar retailer and an online coupon to an online retailer. The instant rewards notification tool electronically notifies the subscriber of a special deal or discount on a product or service offered for sale by a partner company. The subscriber receives priority notification of the special deal or discount related to a number of subscriptions the subscriber holds.

Still more features and variations found in still other embodiments include the following. In one aspect, the method also includes offering the subscriber an opportunity to apply for a specified credit card that is made available only to subscribers to the product or service, and, if the subscriber obtains the specified credit card, automatically entering the subscriber in a credit card sweepstakes. If the subscriber uses the credit card to purchase an item from a partner company, he is automatically entered in at least one additional sweepstakes or entered an additional time in the credit card sweepstakes. If the subscriber obtains the specified credit card, he is automatically enrolled in an accelerated rewards program that offers discounts at participating businesses.

In general, in another aspect, an apparatus includes a computer system, and computer-readable media storing program code which when executed on the computer system performs the functions of: in response to a request, by a subscriber, for a subscription to a product or service, wherein said subscription has a subscription period and wherein the subscription period is initially for a first period of time: (a) automatically providing the subscriber with the product or service for the first period of time; (b) automatically entering the subscriber into one or more sweepstakes drawings which occur during said first period of time, said one or more sweepstakes drawings having one or more corresponding jackpots; (c) at the end of the subscription period, automatically renewing the subscription for a next period of time; (d) in connection with the renewed subscription, automatically entering the subscriber one or more sweepstakes drawings which occur during the next period of time; and (e) repeating operations (c) through (e) until the subscriber terminates the subscription.

In general, in still another aspect, a computer implemented method includes enrolling a subscriber in a subscription to a product or service. The subscription has a subscription period and is initially for a first period of time. The method also includes, in connection with the subscription, automatically entering the subscriber into one or more sweepstakes drawings which occur during the subscription period. The method also includes, at the end of the subscription period, automatically renewing the subscription for a next period of time, and in connection with the renewed subscription, automatically entering the subscriber into one or more sweepstakes drawings which occur during the next time period. The operations of automatically renewing the subscription for a next period of time and automatically entering the subscriber into one or more sweepstakes drawing which occur during the next time period are repeated until the subscriber terminates the subscription.

### BRIEF DESCRIPTION OF THE DRAWINGS

FIG. 1 shows a flow chart of the overall operations of the Subscription program.

FIG. 2 shows a flow chart of the operations of the $10,000 Sweepstakes.

FIG. 3 shows a flow chart of the operations of the $1 Million to $5 Million Sweepstakes.

FIG. 4 illustrates the online portion of the Rewards Program part of the program.

FIG. 5 illustrates the Jackpot Marketplace part of the program.

FIG. 6 illustrates the Jackpot Shopping part of the program.

FIG. 7 illustrates the Jackpot Coupons part of the program.

FIG. 8 illustrates the Jackpot Credit Card part of the program.

FIG. 9 illustrates a system for running the program.

### DETAILED DESCRIPTION

Overview of the Program

1-800-JACKPOT, Inc. (Company) offers a Subscription to a Rewards Program, which lasts for a specified period and is automatically renewed. Part of the Company's promotion of the Rewards Program is that with the initial purchase, and each automatic renewal, of the Rewards Program Subscription, the Company automatically enters a Subscriber for free in every drawing of multiple Sweepstakes offered by the Company for as long as the Subscriber maintains their Subscription. Subscribers pay for the specified Subscription period of the Rewards Program with a credit or debit card, allowing for the automatic payment of each automatic renewal of the Rewards Program Subscription, unless the Subscriber affirmatively withdraws from the Rewards Program.

The value of the benefits and rewards of a Rewards Program Subscription greatly exceed the cost of that Subscription. Many of the rewards are available exclusively to Subscribers. The Rewards Program includes an online marketplace of classified ads; an online shopping site that features special deals and discounts; a live rewards update service that brings live updates of especially generous deals and discounts to the desktops or e-mail boxes of Subscribers; a coupon section that includes coupons and special discounts that are updated three times a week; an online Newsletter that is updated three times a week; and the exclusive opportunity to apply for the Jackpot Credit Card, which includes its own integrated rewards as well as free entry into other Sweepstakes.

In order to meet the ever changing needs and desires of Subscribers, the Company partners with other businesses (Partner Companies) that are willing to offer rewards, and other special deals and discounts to Rewards Program Subscribers. The Company offers a number of incentives to encourage companies to participate in the Rewards Program as Partner Companies. For example, the Company limits advertising on the Company website and in its online Newsletter to its own offerings and to special deals and discounts offered by Partner Companies. Advertising space is made available to Partner Companies based on the deals and discounts they offer Rewards Program Subscribers. The better the deals and discounts a Partner Company offers Subscribers, the better advertising space it receives on the Company's website and Newsletter. The Company also gives priority placing in its online shopping area to Partner Companies that offer the best deals and discounts to Rewards Program Subscribers. The Company also enters Partners Companies for free in their own “Corporate Partners Sweepstakes,” as well as in the other multiple sweepstakes if they have their credit card transactions processed by the Company.

First, an overview of the operation of the Rewards Program will be presented. Then, various features of the Rewards Program will be described in greater detail.

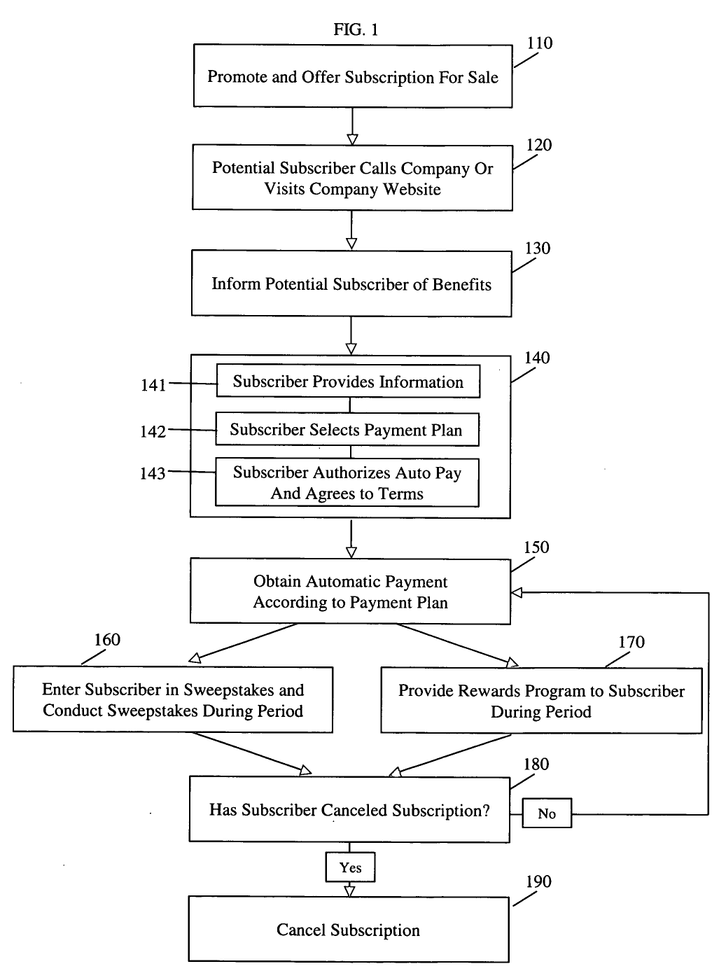

As illustrated in FIG. 1, the Company promotes and offers for sale Subscriptions for the Rewards Program, which offers a vast array of rewards, benefits, special deals and discounts that are updated and automatically renew three times a week to meet the ever changing needs and desires of Subscribers (110). The Company places television, newspaper, and Internet ads, for example, promoting both the Rewards Program and the multiple Sweepstakes.

If a potential Subscriber is interested in purchasing a Subscription, he either visits the Company's website, which directs the potential Subscriber to a “New Subscribers” webpage or calls the Company's toll-free number (1-800-JACKPOT), and reaches either a live or automated operator (120). The “New Subscribers” webpage directly interfaces with the Company's Subscriber database and is able to utilize the information (described below) that the potential Subscriber provides to create his account. If the potential Subscriber calls the toll-free number and reaches a live or automated operator, the operator enters the Subscriber's account information directly into the Company's Subscriber database, in association with the Company's computers.

Depending on how the potential Subscriber contacts the Company, either the Company's website or a live or automated operator informs the potential Subscriber of the many benefits associated with a Subscription to the Rewards Program (130).

This includes the following information:

a. The Rewards Program. All the rewards, benefits, special deals and discounts associated with the Rewards Program updated three times a week to meet the ever changing needs and desires of Subscribers.
b. $10,000 Jackpots Sweepstakes. Automatic free entry into every $10,000 jackpot drawing, in which one lucky contestant is guaranteed to win a $10,000 jackpot, held three times a week.
c. $1 Million to $5 Million Sweepstakes. Automatic free entry into every $1 million to $5 million jackpot drawing which are held three times a week.
d. Super Jackpot. If the jackpot for the $1 Million to $5 Million Sweepstakes reaches $5 million, or if a predetermined date has passed, and a winner has not been selected during a regular drawing, the Subscriber is automatically entered for free into a Super Jackpot drawing in which the Super Jackpot is guaranteed to be awarded.
e. Jackpot Rewards Credit Card. The opportunity to apply for the Jackpot Credit Card which includes the following rewards and benefits:
   i. Jackpot Points. Automatically awards Jackpot Points to Cardholders every time they use their Jackpot Credit Card.
   ii. Jackpot Accelerated Rewards Program. Automatically enrolls Cardholders in the Jackpot Accelerated Rewards Program, which enables Cardholders to automatically receive savings of as much as 20% when they use their Jackpot Credit Card to dine at participating restaurants, stay at participating hotels, or shop at participating retailers.
   iii. Jackpot Credit Card Sweepstakes. Automatically enters Jackpot Cardholders for free in the Jackpot Credit Card Sweepstakes, which offers Jackpot Cardholders eleven additional chances to win valuable prizes during drawings held three times a week.
   iv. Jackpot Accelerated Rewards Sweepstakes. Jackpot Cardholders are automatically entered for free in the Jackpot Accelerated Rewards Sweepstakes each time they make a purchase using their Jackpot Credit Card from a participating retailer.
f. The potential Subscriber is reminded that purchasing a Subscription is easy. He needs only to make a single call using the Company's toll-free number or visit the Company's website in order to subscribe. Once the Subscriber purchases his Subscription it automatically renews and continues indefinitely unless he proactively cancels his Subscription.
g. The potential Subscriber is told that there is no long-term commitment. The Subscriber is permitted to cancel his Subscriptions at any time and will be refunded for each update of the Rewards Program that he has yet to receive at the time of cancellation.

The potential Subscriber then provides the Company necessary information to create a Subscriber Account (140). Depending on how the potential Subscriber contacted the Company, he either fills in an online customer information form on the “New Subscriber” webpage or provides his information to the live or automated operator.

First, the Subscriber provides necessary personal information and payment information (141):
1. Name (as it appears on his credit card)
2. Address, city, state, zip code, and country (as they appear on his credit card statement)
3. Type of Credit Card (e.g., Visa, MasterCard, American Express, Discover)
4. Credit Card Number and Expiration Date
5. Date of Birth
6. Answer to a security code question, like “mother's maiden name”

The operator or website encourages but does not require the Subscriber to provide his telephone number and e-mail address. The Subscriber also selects the number of Rewards Program Subscriptions he wishes to purchase. He has the option of purchasing multiple Subscriptions to the Rewards Program.

Next, the Subscriber selects his automatic Subscription payment option (142). The Company provides the Subscriber with two automatic payment options:
1. $1.25 Per Update. The Subscriber can choose to have his credit card automatically charged by the Company's computers $1.25 with the initial purchase of the Subscription and every automatic renewal thereafter.
   a. Once the Subscriber purchases his Subscription, it is automatically renewed by the Company's computers every Monday, Wednesday, and Friday, i.e., with each update of the Reward Program, and continues indefinitely unless he proactively cancels his Subscription.
   b. Every Monday, Wednesday, and Friday, the Company's computers determine if the Subscriber has cancelled his Subscription, prior to 12 a.m. eastern time of the renewal day. If the Subscriber has cancelled their Subscription, the Company's computers stop charging the Subscriber's credit card, and cancel his enrollment in the Rewards Program.
   c. If the Subscriber has not cancelled his Rewards Program Subscription, the Company's computers charge the Subscriber's credit card $1.25 per Subscription and contributes $0.63 or more of the $1.25 Subscription fee to the $1 Million to $5 Million Sweepstakes jackpot.
2. $12 Pre-Payment Option. The Subscriber can choose to have his credit card automatically charged $12 by the Company's computers with the initial purchase of a Rewards Program Subscription and every four weeks thereafter.
   a. The pre-payment option saves the Subscriber a defined amount, e.g., 20%, on the cost of a Subscription.
   b. Once the Subscriber purchases his Subscription, the Company's computers automatically renew the Subscription every Monday, Wednesday, and Friday, continuing indefinitely unless the Subscriber proactively cancels his Subscription.
   c. If the Subscriber cancels his Subscription, the Company's computers stop charging his credit card, and cancel his enrollment in the Rewards Program. In addition, if the Subscriber chose the pre-payment option, the Company's computers automatically refunds the Subscriber $1 for each update of the Rewards Program that he has yet to receive at the time of cancellation.
      i. The Company's computers automatically renew Rewards Program Subscriptions every Monday, Wednesday, and Friday, at 12 a.m. eastern time. The Company's computers determine before these times whether the Subscriber has canceled his subscription. If a the Subscriber has not cancelled his Rewards Program Subscription, the Company's computers contribute $0.50 or more of the $1.00 Subscription fee for the current Rewards Program update to the $1 Million to $5 Million Sweepstakes jackpot.
      ii. If the pre-payment Subscriber has not cancelled his Subscription and he is at the beginning of a new 4 week pre-payment period, the Company's computer charges the Subscriber's credit card $12 per Subscription and contributes $0.50 or more of the $1.00 Subscription fee for the current Rewards Program update to the $1 Million to $5 Million Sweepstakes jackpot.

Next, the Subscriber agrees to the terms and conditions of the Rewards Program Subscription Agreement, and authorizes automatic payment of the Subscription fee (143). If the Subscriber is subscribing online, the website requires him to check a box to agree to the terms and conditions of a Rewards Program Subscription Agreement. If the Subscriber called the toll-free number, the live or automated operator requires him to provide verbal confirmation that he agrees to the terms and conditions of the Rewards Program Subscription Agreement. The Subscriber completes the purchase by authorizing the Company's computer or operator to process the Subscription application. In doing so the Subscriber authorizes the Company to use its computers to process the automatic payment of the current Subscription fee, and future Subscription fees, by charging the provided credit card in accordance with the automatic payment option selected previously (142). If the Subscriber is subscribing online, he completes this process by clicking the “Complete Purchase” icon on the website. Subscribers who called the toll-free number complete this process by verbally authorizing the operator to have the Company's computers complete the purchase of the Subscription. The Subscriber's verbal authorization is electronically recorded by the Company's computers or a third party's computers and stored electronically in a storage device for verification purposes.

Having received sufficient Subscriber information, the Company's computers create a Subscriber account (140). To create a Subscriber account, the Company's computers in communication with the Company's Subscriber database generate a unique Subscriber account number for billing, collections, and customer service. The Company's computers also assign the Subscriber a login so that he can access the online benefits of the Rewards Program. If the Subscriber provides his e-mail address, the Company's computers assign that address as the Subscriber login; otherwise, the Company's computers generate the login. The Company's computers also provide the Subscriber with a password for accessing online benefits. If the Subscriber provides his e-mail address, the Company's computers automatically e-mail him a confirmation of his login and his password. If the Subscriber did not provide an e-mail address, the Company's computers provide the Subscriber with a login and password. The operator or the webpage communicates the login and password to the Subscriber and encourages the Subscriber to print a copy of or write down his login and password for his records.

Next, the Company's computers verify that the Subscriber's information is accurate, and obtain automatic payment for the Subscription by charging the Subscription fee to the credit card the Subscriber provided the Company, in accordance with the automatic payment option selected by the Subscriber (150).

The Company's computers then enroll the Subscriber in the Rewards Program (170) thereby enabling the Subscriber to begin taking advantage of the rewards, deals and special discounts available to Rewards Program Subscribers. The Company's computers also enter the Subscriber for free into the drawings of multiple Sweepstakes that the Company holds during the Subscription period (160). The Sweepstakes and Rewards Program are described in greater detail below.

Before automatically renewing the Subscriber's Rewards Program Subscription, the Company's computers determine whether the Subscriber has canceled his Subscription (180). The Subscriber can cancel his Subscription by calling the Company's toll-free number or by logging in to his Subscriber Account and submitting his cancellation online. If the Subscriber did not cancel his Subscription, the Company's computers obtain automatic payment for the next Subscription period (150), and the Subscriber continues to receive the Rewards Program (170) and free entries into the multiple Sweepstakes (160). If the Subscriber canceled his Subscription, then the Company's computers cancel the Rewards Program Subscription as well as the automatic payment of same (190).

Multiple Sweepstakes

The Company's computers automatically enter the subscriber for free into multiple sweepstakes when he purchases his Rewards Program subscription, and with each subscription renewal. The Company holds two contemporaneous Sweepstakes: a $10,000 Sweepstakes and a $1 Million to $5 Million Sweepstakes. The two Sweepstakes have separate sets of numbers, which form the Subscriber's free entry into each Sweepstakes. The drawings for the Sweepstakes are held on the same nights of the week, e.g., on Mondays, Wednesdays, and Fridays. The $10,000 Sweepstakes has a guaranteed jackpot winner in each Sweepstakes drawing, and the $1 Million to $5 Million Sweepstakes offers contestants the chance at winning the $1 Million to $5 Million jackpot during each Sweepstakes drawing.

$10,000 Sweepstakes

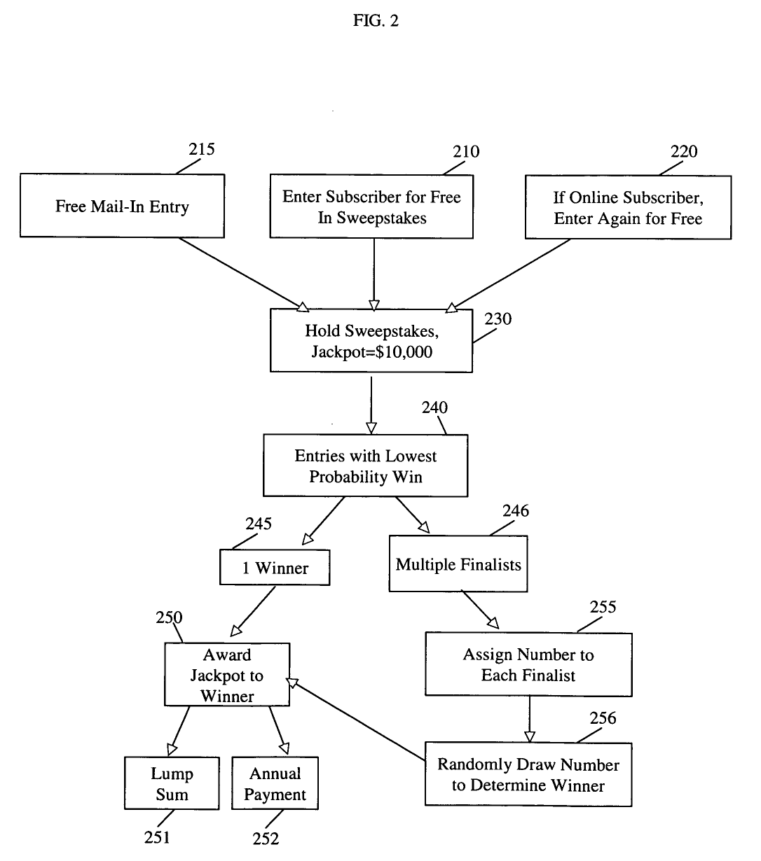

FIG. 2 shows a flow chart of the operation of the $10,000 Sweepstakes. The $10,000 Sweepstakes guarantees that one contestant will win a $10,000 jackpot during each drawing.

When a Subscriber purchases a Rewards Program Subscription, the Company's computers randomly assign the Subscriber a set of five white numbers out of a total of 65 white numbers and one red “JACKPOT” number out of a total of 65 red “JACKPOT” numbers, which forms the Subscriber's free entry for that Subscription in the $10,000 Sweepstakes (210). Each Subscription receives its own set of numbers, and each set of numbers represents a separate entry into the $10,000 Sweepstakes. The Subscriber has the option of selecting his own numbers by entering them on an appropriate Company website. These selected numbers represent the Subscriber's entry in the current and all future $10,000 Sweepstakes drawings, unless he changes his numbers or cancels his Subscription.

If the Subscriber purchases his Subscription online, the Company's computers assign him a second set of “bonus” numbers that represents a second free entry into the next drawing of the $10,000 Jackpot Sweepstakes, thereby doubling his chance of winning (220). The second set of “bonus” numbers represent an entry in the next $10,000 Sweepstakes drawing but expire after that drawing and do not apply to any additional drawings. Additionally, anyone eligible to enter the Sweepstakes by applicable law may enter for free by mail (215).

Drawings for the $10,000 Sweepstakes are held every Monday, Wednesday, and Friday at approximately 10 p.m. eastern time (230). The odds of winning the $10,000 Jackpot are determined by the total number of entries in the Sweepstakes at the time of the drawing.

The Company's computers identify the entry with the lowest odds of winning and that entry is the winner (240). For example, if all five white numbers as well as the red “JACKPOT” number of a single entry match the six balls selected in the drawing, the Company awards the contestant holding that entry the $10,000 jackpot (245). It may be the case that no entry matches all six numbers. For example, if no entry matches all five white numbers and the red “JACKPOT” number, but one entry matches all five white numbers, the jackpot is awarded to the contestant whose entry matches all five white numbers, because this is the entry with the lowest probability, i.e., the most matching numbers (245). Or, if no entry matches all five white numbers and the red “JACKPOT” number, or all five white numbers, but one entry matches four white numbers and the red “JACKPOT” number, the jackpot is awarded to the contestant holding that entry.

It may also be the case that there are multiple winning entries, in which case there are multiple finalists for the drawing (246). For example, if no entry matches all five white numbers and the red “JACKPOT” number during a $10,000 Sweepstakes drawing, but multiple entries match all five white numbers, the Company treats these contestants as finalist for the jackpot, and assigns each of them a unique identifying number (255). The Company then holds a second drawing (256) to randomly choose the unique number of one of these contestants, and awards that contestant the $10,000 jackpot (250). Similarly, if no entry matches all five white numbers and the red “JACKPOT” number or all five white numbers, but multiple entries match four white numbers and the red “JACKPOT” number (246), the Company treats these contestants as finalists for the jackpot and assigns each of them a unique identifying number (255). The Company then holds a second drawing in which the unique number of one of these contestants is randomly chosen (256) and that contestant is awarded the $10,000 jackpot (250).

In general, the Company's computers examine all the entries in a $10,000 Sweepstakes Drawing; identify the entries with numbers that match some or all of the five white numbers and the one red “JACKPOT” number selected during the drawing; organize the entries according to their probability; and select the entry or entries with the lowest probability, e.g., the most matching numbers. Having identified one or more contestants whose entry matches a certain number of the winning numbers with the lowest probability, the Company either awards the $10,000 jackpot to a single winner or holds a second drawing, as set forth above, to determine the winner.

All the Sweepstakes jackpots offered by the Company are jackpot annuities based on 30 equal annual installments payable over 29 years. Jackpot winners must select, at the time of award, one of the following methods of jackpot payment: annual payment of an annuity (252) or a lump sum cash payment (251). If the winner selects the 29 year annuity option, the Company pays the winner in 30 equal annual installments payable over 29 years, making the first payment as soon as is reasonably possible following the winner's election. If the winner selects the lump sum option, the Company pays him a single lump sum payment equal to the present day value of the 29-year annuity. The value of the cash payment option is established prior to each sweepstakes by multiplying the amount of the annuity by a discount factor derived from the current market rates for U.S. Government STRIP bonds.

The $1 Million to $5 Million Sweepstakes

Subscribers to the Rewards Program are automatically entered by the Company's computers for free in the $1 Million to $5 Million Sweepstakes, where contestants have the chance to win a jackpot between $1 million and $5 million during each of the three times a week drawings, for as long as the Subscriber maintains his Subscription. The $1 Million to $5 Million Sweepstakes begins with an initial minimum jackpot of $1 million, which has the potential to grow as large as $5 million. The Company contributes at least 50% of its gross revenues from the sale of Rewards Program Subscriptions to the $1 Million to $5 Million Sweepstakes' jackpot prize money, until the jackpot reaches $5 million. The Company either purchases jackpot insurance or sets aside sufficient funds to guarantee that the Company will be able to award the jackpot if a contestant wins the $1 million jackpot prior to the Company having enough revenue from Subscription sales to pay the $1 million minimum jackpot. Every Subscription purchased using the $1.25 per update payment option reduces the amount being insured by at least $0.63 per update. Every Subscription purchased using the $12 pre-payment option reduces the amount being insured by at least $0.50 per update. Once the Company generates enough revenue from the sale of Rewards Programs Subscriptions to cover the $1 million minimum jackpot, the jackpot begins to grow and has the potential of growing as large as $5 million.

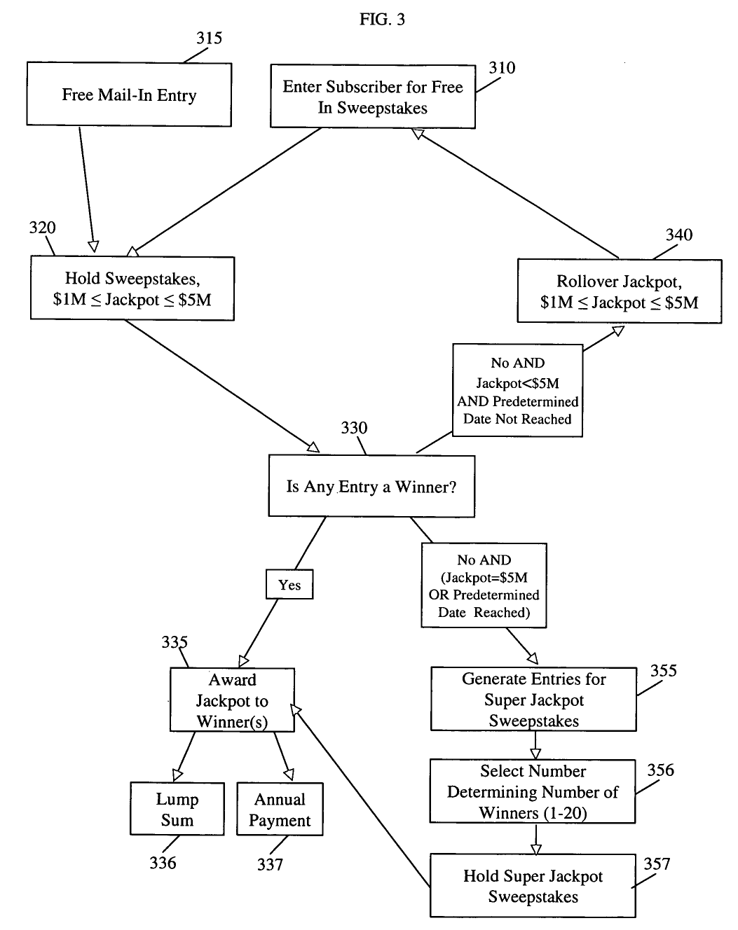

FIG. 3 shows a flow chart of the operations of the $1 Million to $5 Million Sweepstakes.

When a Subscriber purchases their Rewards Program Subscription, the Company's computers randomly assign the Subscriber a set of five white numbers out of a total of 65 white numbers and one red “JACKPOT” number out of a total of 65 red “JACKPOT” numbers which forms the Subscriber's free entry in the $1 Million to $5 Million Sweepstakes (310). Each Subscription receives its own set of numbers, and each set of numbers represents a separate entry. The Subscriber has the option of selecting his own numbers by entering them on an appropriate Company website. These selected numbers represent the Subscriber's entry in the current and all future $1 Million to $5 Million Sweepstakes drawings, unless he changes his numbers or cancels his Subscription. Additionally, anyone eligible to enter the Sweepstakes by applicable law may enter for free by mail (315).

The Company holds drawings for the $1 Million to $5 Million Sweepstakes every Monday, Wednesday, and Friday at approximately 10:30 p.m. eastern time (320). Drawings for the $1 Million to $5 Million Sweepstakes involve drawing five white balls out of a drum containing 65 white balls and one red “JACKPOT” ball out of a drum containing 65 red “JACKPOT” balls. Thus, the odds of winning the $1 million to $5 million jackpot are 1 in 536,892,720.

After drawing the six balls, the Company's computers determine if any entry is a winner (330). If a contestant's entry matches the five white numbers plus the red “JACKPOT” number drawn, the Company awards that contestant with the jackpot (335).

If there is no winner of the $1 million to $5 million jackpot, the Company's computers roll the jackpot over into the next drawing, where it continues to grow as described above until the jackpot reaches $5 million or until a predetermined date is reached (340).

Super Jackpot. If the jackpot for the $1 Million to $5 Million Sweepstakes reaches $5 million, or the predetermined date is reached, and a winner has not yet been selected during the regular Sweepstakes drawings, the Company holds a Super Jackpot drawing the next night, at approximately 10:30 p.m. eastern time, in which time the Super Jackpot is guaranteed to be awarded (355).

If the jackpot reaches $5 million before the predetermined date, the jackpot is capped, and does not grow any larger. The revenue generated from Subscription sales just prior to the final drawing for the Super Jackpot may exceed $5 million, in which case the Company's computers roll the additional revenue over into the next jackpot (Super Jackpot Rollover Revenue). The Sweepstakes entries associated with the Super Jackpot Rollover Revenue do not rollover but instead count as entries in the current Super Jackpot drawing.

If the jackpot has not grown to $5 Million by the predetermined date, the jackpot of the Super Jackpot is an amount less than $5 Million but not less than 50% of the gross revenue from Rewards Program Subscription Sales. For example, the Company may determine that if the jackpot is not awarded by December 30, it will hold a Super Jackpot drawing on December 31 in which it guarantees that it will give away a jackpot equal to or greater than 50% of the gross revenue from Rewards Program Subscription sales, regardless of the jackpot's size. Using this example, if the Company holds a regular $1 Million to $5 Million Sweepstakes drawing on December 30 for a $2 million jackpot and no one wins the jackpot, the Company reserves the right to hold a Super Jackpot drawing the next night at which time it awards the $2 million jackpot according to the rules that govern the awarding of a Super Jackpot, described below.

To award the Super Jackpot, first the Company's computers, connected to the Subscriber database, take all of the $1 Million to $5 Million Sweepstakes entries since the last jackpot payout and randomly assign each entry a unique identifying number (355). Subscribers with multiple prior entries are randomly assigned a block of consecutive numbers by the Companies computers to facilitate their comparison to the winning number or numbers chosen in the Super Jackpot drawing.

Prior to the Super Jackpot drawing, the Company draws one ball out of a drum with 20 balls in it; the number on the ball determines the number of winning numbers the Company will select during the Super Jackpot drawing. The contestants holding the winning numbers will equally divide the jackpot of the Super Jackpot (356). For example, if the number “16” is selected, then the Company's computers select 16 numbers during the Super Jackpot drawing and the contestants holding those 16 numbers equally divide the jackpot of the Super Jackpot.

The Company then holds the Super Jackpot drawing, in which it randomly selects 16 sets of numbers that represent the winning numbers of the Super Jackpot. The spectrum of numbers utilized in the Super Jackpot drawing, e.g., 65 white numbers and 65 red “JACKPOT” numbers, and the odds of winning the Super Jackpot are determined by the total number of entries in the Sweepstakes at the time of the drawing. The contestants holding entries that match the 16 winning numbers are the winners of the Super Jackpot, and they equally divide the Super Jackpot (335).

As for the $10,000 Sweepstakes, the winner(s) of the $1 Million to $5 Million and Super Jackpot Sweepstakes select, at the time of award, one of the following methods of jackpot payment: annual payment of an annuity (337) or a lump sum cash payment (336).

Jackpot Entries, Payouts, and Eligibility

Multiple Winners of a Single Jackpot. If two or more Subscribers win in the same drawing, e.g., by matching all six winning numbers in the same drawing, those Subscribers share the jackpot equally, and each may select his payout method of choice.

Entry Deadline. Contestants can enter the various Sweepstakes until 7 p.m. eastern time on the day of the drawings.

Free Entry. Entry into the Sweepstakes is free.
a) Rewards Program Subscribers. Subscribers to the Rewards Program are automatically entered for free into the next drawing for each of the Sweepstakes drawings. Subscribers with multiple Subscriptions receive multiple free entries into the next Sweepstakes drawing. Subscribers who purchase a Rewards Program Subscription before 7 p.m. eastern time on the day of a Sweepstakes drawing are automatically entered for free in that night's Sweepstakes drawings and each Sweepstakes drawing thereafter for as long as they maintain their Subscription. Subscribers who purchase a Rewards Program Subscription after 7 p.m. eastern time on the day of a drawing are not entered for free in that night's Sweepstakes drawing but are instead automatically entered for free in the next Sweepstakes drawing held after that night's drawing and each Sweepstakes drawing thereafter for as long as they maintain their Subscription.
b) Free Alternative Method of Entry. Any person, including Subscribers and non-Subscribers, can enter the Sweepstakes for free by mailing an entry form and a self-addressed stamped envelope to the Company's headquarters. Each Sweepstakes has its own entry form. Contestants can enter each Sweepstakes as often as they like but each entry must be hand written by the contestant and sent separately by first-class mail. Mail-in entries that are received before 7 p.m. eastern time on the day of a drawing are automatically entered for free in that night's Sweepstakes drawing. Mail-in entries that are received after 7 p.m. eastern time on the day of a drawing are not entered for free in that night's Sweepstakes drawing but are instead automatically entered for free in the next Sweepstakes drawing held after that night's drawing.

Equal Chance of Winning. All methods of entry, including mail-in entries, have the same chance of winning.

Must Be 18 Years of Age or Older to Play. Subscribers and non-subscribing entrants must be 18 years of age or older to play, must provide their name, address, and date of birth, and are encouraged but not required to provide their telephone number and e-mail address.

Worldwide. The Sweepstakes will be available to contestants worldwide whose participation is not prohibited by applicable law.

Rewards Program

The Rewards Program and its features will now be described in more detail.

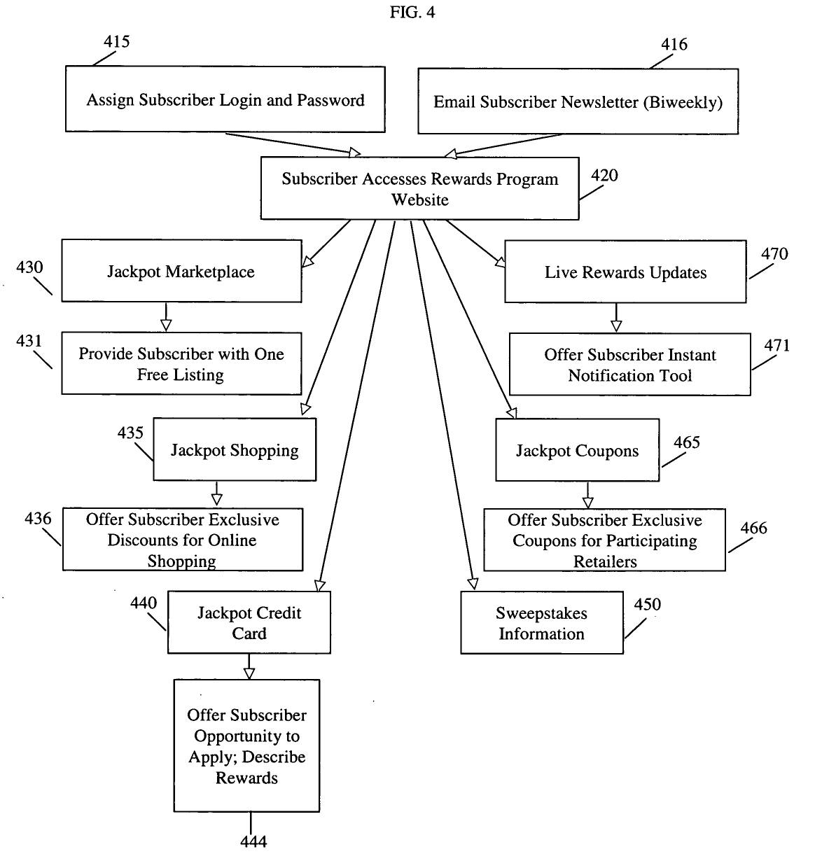

FIG. 4 illustrates the online portion of the Rewards Program. As mentioned above, when a Subscriber purchases a Subscription, the Company's computers assigns a Subscriber login and password, which allow the Subscriber to access their Rewards Program account on the Company's website (415). The Jackpot Rewards Program is updated three times a week. The Company distributes notices of the latest update via an online Newsletter that the Company's computers e-mail to the Subscriber three times a week (416). When the Subscriber opens the Newsletter, he is linked to the Company's website, where he has easy access to the online marketplace, online shopping, as well as all the rewards, coupons, special deals and discounts. The online Newsletter enables the Company to efficiently and cost-effectively reach a global market.

When the Subscriber accesses the Rewards Program website (420) by either visiting it directly or by clicking the appropriate link within the Newsletter, the website gives the Subscriber the option of accessing linked webpages that contain rewards and benefits included in the Rewards Program Subscription. The website also provides advertising space to Partner Companies that provide particularly valuable rewards to Subscribers, as described in greater detail below. The website also promotes the various Sweepstakes and provides information about the size of the various jackpots and a countdown clock that shows the hours, minutes, and seconds until the next drawing for the various sweepstakes (450).

The value to the Subscriber of the benefits and rewards of the Rewards Program greatly exceed the cost of the Subscription. The website includes links to the following rewards and benefits, which the Subscriber has the option of accessing, and which are described in greater detail below:

Jackpot Marketplace (430) is a site where Subscribers are allowed to list homes and cars for sale, job opportunities and resumes, personal, and classified ads. Each Subscription entitles the Subscriber to post one listing at a time on the Company's Marketplace website (431).

Jackpot Shopping (435) is an online shopping site that features special deals and discounts that are updated three times per week and are available exclusively to Subscribers (436). In addition to the special deals and discounts that will be available exclusively for Subscribers, Jackpot Shopping aggregates and indexes millions of deals and discounts available from online retailers and brick and mortar retailers located in and around the Subscriber's zip code.

“Cha-Ching” Live Rewards Updates (470) is an instant notification tool that brings live rewards updates of especially generous deals and discounts to the desktops or e-mail boxes of Rewards Program Subscribers. Subscribers have the option of downloading and installing an instant notification tool (471) or receiving “Cha-Ching” Live Rewards Updates via e-mail. When the Company's Partner Companies have excess inventory or wish to run a promotion they can attempt to quickly sell their inventory or promote their product by having a Live Rewards Update sent out by the Company's computer to the desktops or e-mail boxes of Subscribers.

Jackpot Coupons (465) is a site that features printable coupons for participating online and brick and mortar retailers (466) and online coupons redeemable online at the Company's website or the website of the partner Company offering the discount. Over $200 worth of coupons and special discounts are updated three times a week, and available exclusively to Rewards Program Subscribers.

Jackpot Credit Card (440) is a site that offers Subscribers the exclusive opportunity to apply for the Jackpot Credit Card, and describes rewards associated with the card (444). The rewards portion of the Jackpot Credit Card has four main components, which are also described in greater detail below:
1. The Jackpot Points Rewards Program. Jackpot Cardholders receive one Jackpot Point for every dollar of purchases they make using their Jackpot Credit Card.
2. The Jackpot Accelerated Rewards Program. Jackpot Cardholders are automatically enrolled by the Company's computers in the Jackpot Accelerated Rewards Program in which Cardholders automatically receive additional Jackpot Points of as much as 20 Points per dollar spent when they use their Jackpot Credit Card to dine at participating restaurants, stay at participating hotels, or shop at participating retailers.
3. The Jackpot Credit Card Sweepstakes. Jackpot Cardholders are automatically entered for free by the Company's computers into the Jackpot Credit Card Sweepstakes where Cardholders will have eleven additional ways to win millions of dollars worth of prizes and a better than 1 in 3 chance of winning something during each of the three times a week drawings.
4. The Jackpot Accelerated Rewards Sweepstakes. Jackpot Cardholders are automatically entered for free by the Company's computers in the Jackpot Accelerated Rewards Sweepstakes each time they make a purchase using their Jackpot Credit Card from a participating retailer.

Partner Companies

Companies are always looking for new and innovative ways to promote their products and reward their customers. An effective means of promoting products and rewarding customers is by offering coupons, and other special deals and discounts. In 2003, approximately 258 billion coupons were distributed in the United States, making it a popular way of rewarding customers. The Internet offers companies the ability to communicate in an interactive manner with numerous potential customers. As a result, Internet coupons represent an area of large potential growth for the coupon market. Advertising on the Internet has, however, become increasingly expensive, particularly for high traffic Internet sites. Because of the prohibitive expense, the current growth in Internet coupons is typically limited to large corporations with large media budgets.

The Company changes this market dynamic by creating a rewards based marketplace, by providing companies (Partner Companies) access to large numbers of Subscribers based on the values of the benefits, rewards, special deals and discounts that they offer those subscribers rather than the size of their marketing budget. This new rewards based marketplace is of mutual benefit to Subscribers and to Partner Companies that are willing offer rewards, special deals and discounts in order to reach Subscribers to the Rewards Program. The better the deals and discounts a Partner Company offers Subscribers, the better access they receive to those Subscribers. In short, the Company creates a marketplace that rewards Partner Companies based on the rewards they provide its Subscribers.

One example of a Partner Company is a commercial bank (Partner Bank) that provides special deals and discounts to Subscribers for a broad range of financial services (e.g., credit cards, checking accounts, investment accounts, retirement accounts, college savings accounts, home mortgage, car and truck financing, etc.) Additionally, the Partner Bank may offer the Jackpot Credit Card to Subscribers, jointly with the Company.

The following are a few examples of the rewards and benefits available to Partner Companies that participate in the Rewards Program by providing special deals and discounts to Rewards Program Subscribers:
1. Advertising Space. The Company limits advertising in the Newsletter and on the Company website to its own offerings and to special deals and discounts offered by Partner Companies. Advertising space is made available to Partner Companies based on the deals and discounts they offer Rewards Program Subscribers. The better the deals and discounts a Partner Company offers Subscribers, the better advertising space they receive on the Company's website and Newsletter. This creates a strong incentive for Partner Companies to increase the value of the rewards, deals, and discounts they offer Subscribers. The increased value of the rewards, deals, and discounts that Partner Companies provide Subscribers, makes the Rewards Program more valuable to Subscribers, and may increase the Subscriber base. In turn the ability to reach larger numbers of Subscribers makes advertising on the Company's website more valuable to Partner Companies and makes them more inclined to offer better deals and discounts to Subscribers, which further increases the value of the Rewards Program.
2. Priority Placement in Shopping Searches. The Company gives priority placement for Jackpot Shopping search results to the Partner Companies that offer the best deals and discounts to Rewards Program Subscribers.
3. Savings on Credit Card Transactions. The Company agrees to match or lower what Partner Companies currently pay to have its credit card transactions processed. If the Company is unable to match or lower what the company is currently paying, the Company provides the Partner Company a free one-year Subscription to the Rewards Program.
4. The Chance to Win Millions. Every time the Company awards a $1 Million to $5 Million jackpot, the Company also awards a $10,000 jackpot to one Partner Company participating in the Rewards Program. Partner Companies receive free entries into a Partner Companies Sweepstakes every time a Jackpot Credit Card is used to purchase something from their Company. The number of free entries into the Partner Companies Sweepstakes a company receives is in direct proportion to the number of Jackpot Points they award to the Jackpot Credit Cardholders. For example, if the Partner Company awards 10 Jackpot Points for every $1 spent using a Jackpot Credit Card, that company receives 10 entries into the Partner Companies Sweepstakes for every dollar spent using a Jackpot Credit Card.
5. Double Their Chances to Win Millions. Partner Companies that have their credit card transactions processed by the Company will double their chances of winning the Partner Companies Sweepstakes. For example, if the company awards 10 Jackpot Points for every $1 spent using a Jackpot Credit Card and they have their credit card transactions processed by the Company, the company receives 20 entries into the Partner Companies Sweepstakes for every dollar spent using a Jackpot Credit Card.
6. Free Rewards Program Subscription. Partner Companies that have their credit card transactions processed by the Company receive a free Subscription to the Rewards Program, which automatically enters them for free in the $10,000 Sweepstakes and the $1 Million to $5 Million Sweepstakes.

Jackpot Marketplace

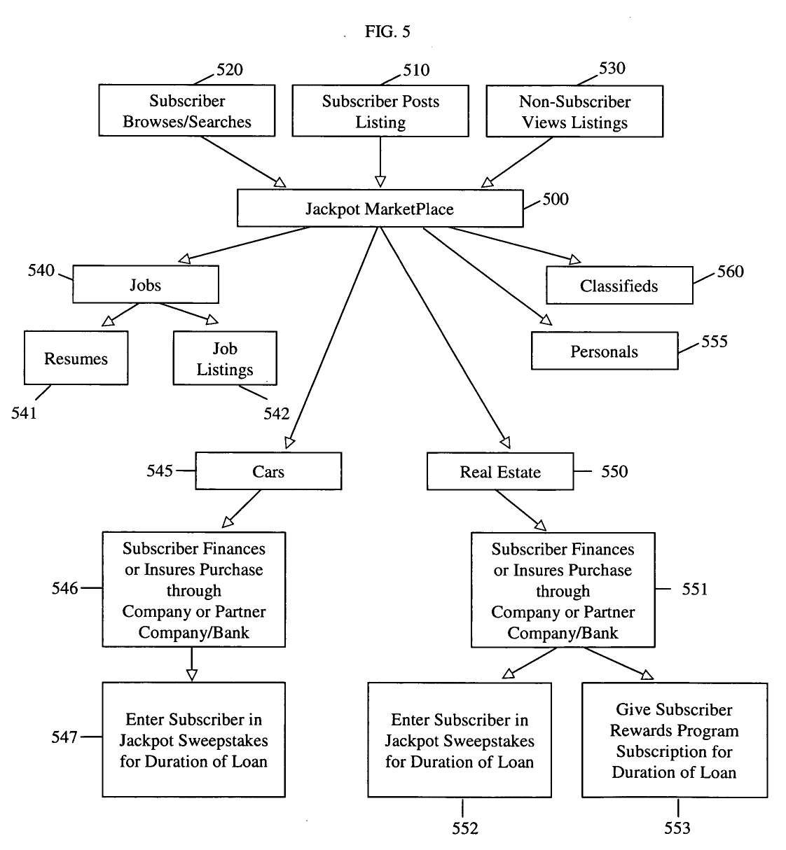

FIG. 5 illustrates the Jackpot Marketplace part of the program.

Jackpot Marketplace (500) is an online site for classified ad listings that are broken into five main sections: Real Estate, Cars, Jobs, Personals, and Classifieds. The Company's computers acquire classified ad listings for the Jackpot Marketplace from two sources:
1. Internet Search, Aggregation and Indexing. The Company's computers use meta search technology to search the Internet in order to aggregate and index millions of online classified ads listed on various online classified ad listing sites run by non-Subscriber third party companies, e.g. Cars.com, Vehix.com, Autotrader.com, Monster.com, HotJobs.com, eBay Real Estate, Yahoo Real Estate, etc. This enables visitors to the Company's website to access a broad range of listings from various sites when they perform a search on the Jackpot Marketplace.
2. Subscribers. Subscribers are allowed to post one classified ad at a time, per Subscription for as long as they maintain their Subscription to the Rewards Program (510).
   a. Subscribers listing are posted by the Subscriber and stored on the Company's computers.
   b. Subscribers can discontinue a listing at any time and can change or replace their listings once per Subscription period, or as often as three times a week.
   c. The cost to list such an item on Jackpot Marketplace is included in the Reward Program's Subscription fee.
   d. Classified ads posted by Subscribers receive priority placement above the non-Subscribers listings from third party classified ad listing sites that have been aggregated and indexed by the Company's computers using meta search technology.
   e. Advantages of Owning Multiple Subscriptions. Subscribers interested in maintaining multiple classified ad listings at the same time are able to do so by purchasing multiple Subscriptions. The Company's computers identify which Subscribers have multiple Subscriptions and give them priority placement for applicable search results. The more Subscriptions a Subscriber owns, the higher placement his classified ads receive in the applicable search results. Subscribers can to have multiple listings in multiple categories (Real Estate, Cars, Jobs, Personals, and Classifieds) at the same time. For example, a Subscriber who purchases ten Subscriptions can post ten different classified ads at the same time, and his ten ads are guaranteed to be listed higher in an applicable search result than similar listings by a Subscriber with less than ten Subscriptions. A Subscriber with five Subscriptions can post five different classified ads at the same time and his five ads are guaranteed to be listed higher in a search result than similar listings by a Subscriber with less than five Subscriptions. A Subscriber with a single Subscription can post one classified ad and his ad is guaranteed to be listed higher in a search result than a similar listing by a non-Subscriber third party that has been aggregated and index by the Company's computers using meta search technology.
   f. Companies can be Subscribers. Companies, including but not limited to Partner Companies, can become Subscribers by purchasing one or more Subscriptions to the Rewards Program, and can post corresponding classified listings in the Marketplace like any other Rewards Program Subscriber. In general, a company holding a Subscription can also perform all of the actions described herein that are ascribed to Subscribers, including receiving free entries into the multiple Sweepstakes.

Classified listings on the Jackpot Marketplace can be viewed and accessed by both Subscribers (520) and non-Subscribers (530), but only Subscribers can post classified ads directly to the Jackpot Marketplace and receive priority placement for those ads.

The Jackpot Marketplace has five main sections: Real Estate, Cars, Jobs, Personals, and Classifieds.
1. The Cars section (545). The Jackpot Marketplace includes a Cars section (545) where Subscribers can place classified ads for cars, trucks, automotive parts, and other vehicle-related merchandise.
   a. Subscribers are entitled to one classified ad at a time per Subscription at no additional expense above the Rewards Program Subscription fee. Subscribers, including new and used car dealers and other car owners, who wish to list multiple vehicles at the same time can do so by purchasing multiple Subscriptions. Purchasing multiple Subscriptions also provides the seller priority placement in search results which has the potential of dramatically increasing the number of potential buyers that see their listings.
   b. For example, a car dealer who purchases ten Subscriptions can post ads for ten different cars and his ten cars are guaranteed to be listed higher in a search result than similar cars listed by a Subscriber with less than ten Subscriptions. A Subscriber with five Subscriptions can post ads for five different cars and his five cars are guaranteed to be listed higher in a search result than similar cars listed by a Subscriber with less than five Subscriptions. A Subscriber with a single Subscription can post an ad for one car and his car is guaranteed to be listed above the car listings on third party sites by non-Subscribers, which have been aggregated and index by the Company's computers using meta search technology.
   c. For example, if a visitor to the Company's website is interested in purchasing, e.g. a 2004 Ford Explorer, he would type “2004 Ford Explorer” into the Marketplace “Search” box and click “Search.” The Company's computers search and index all of the 2004 Ford Explorer listings posted by its Subscribers in descending order with the Subscribers with the most Subscriptions being listed first. At the same time, the Company's computers utilize meta search technology to aggregate and index all of the 2004 Ford Explorer listings posted at various online car listing sites, e.g. Cars.com, Vehix.com, Autotrader.com, eBay Motors, Yahoo Autos, Edmunds.com, kbb.com, etc. If the visitor sees a 2004 Ford Explorer that interests him that is listed by a Rewards Program Subscriber, the visitor clicks on the listing and the Company's computers provide the complete listing for the Explorer that is hosted on the Company's computers. If the visitor sees a 2004 Ford Explorer that interests him that is listed by a third-party classified ad listing site for cars, such as Vehix.com, he clicks on the listing and the Company's computers take him to the Vehix.com website, where he can view a complete description of the vehicle.
   d. The Company and Partner Companies, e.g., Partner Banks and insurance companies, have the exclusive right to advertise vehicle financing and insurance in the Cars section of the Marketplace. If a Subscriber purchases a vehicle with financing provided by the Company or a Partner Company, or insures a vehicle with insurance provided by the Company or a Partner Company (546), that Subscriber automatically receives a free Subscription to the Rewards Program and a free entry into the multiple Sweepstakes offered by the Company for as long as he has the car loan or insurance through the Company or Partner Company (547).
2. The Real Estate section (550). The Jackpot Marketplace includes a Real Estate section (550) where Subscribers can list properties for sale or rent at no additional expense above the Rewards Program Subscription fee.
   a. Subscribers are entitled to one classified ad at a time per Subscription at no additional expense above the Rewards Program Subscription fee. Subscribers, including realtors and property owners, who wish to list multiple properties at the same time can do so by purchasing multiple Subscriptions. Purchasing multiple Subscriptions also provides the seller priority placement in search results which has the potential of dramatically increasing the number of potential buyers that see their listings.
   b. For example, a real estate agent who purchases ten Subscriptions can post ads for ten different homes, and his ten homes are guaranteed to be listed higher in a search result than similar homes listed by a Subscriber with less than ten Subscriptions. A Subscriber with five Subscriptions can post ads for five different homes, and their five homes are guaranteed to be listed higher in a search result than similar homes listed by a Subscriber with less than five Subscriptions. A Subscriber with a single Subscription can post an ad for one home, and his home is guaranteed to be listed above the real estate listings on third party sites by non-Subscribers that have been aggregated and index by the Company's computers using meta search technology.
   c. For example, if a visitor to the Company's website is interested in purchasing, e.g. a three bedroom, two bath home, priced at less than $500,000 and located in a specific zip code, he visits the Jackpot Marketplace Real Estate webpage and under Real Estate Search enters a search criteria of: bedrooms “3”, bathrooms “2”, price range “less than $500,000”, and location “city and state” or “zip code.” The Company's computers search and index all of the three bedroom, two bath homes priced at less than $500,000 within that geographic area, posted by its Subscribers, in descending order with the Subscribers with the most Subscriptions being listed first. At the same time, the Company computers utilize meta search technology to aggregate and index all of the three bedroom, two bath homes priced at less than $500,000 within that geographic area listing posted at various online real estate sites by realtors and home owners, e.g., eBay Real Estate, Yahoo Real Estate, ForSaleByOwner.com, etc. If the visitor sees a house that interests him that is listed by a Rewards Program Subscriber, he clicks on the listing, and the Company's computer opens a complete listing for the house that is hosted on the Company's computers. If the visitor sees a house that interests him that is listed by another classified ad service, like eBay Real Estate, he clicks on the listing and it takes them to the eBay Real Estate website where he can view a complete listing of the house.
   d. The Company and Partner Companies, e.g., mortgage brokers, banks, and insurance companies, have the exclusive right to advertise home mortgage loans and home-owners or renters insurance in the Real Estate section of the Jackpot Marketplace. Subscribers who purchase a home mortgage loan or home-owners or renters insurance through the Company or a Partner Company (551) receive a free Subscription to the Rewards Program (553) and are automatically entered for free into various Sweepstakes offered by the Company for as long as they have their home mortgage or home owner's insurance through the Company or a Partner Company (552).
3. The Jobs section (540). The Jackpot Marketplace includes a Jobs section (540) where Subscribers are entitled to post job opportunities (542) or their resume (541).
   a. Subscribers are entitled to one classified ad at a time per Subscription at no additional expense above the Rewards Program Subscription fee. Subscribers, including Companies, who wish to list multiple jobs at the same time can do so by purchasing multiple Subscriptions. Purchasing multiple Subscriptions also provides the company priority placement in search results, which has the potential of dramatically increasing the number of potential job seekers that see their listings.
   b. For example, a company who purchases ten Subscriptions can post ads for ten different jobs and its ten jobs are guaranteed to be listed higher in a search result than similar jobs listed by a Subscriber with less than ten Subscriptions. A Subscriber with five Subscriptions can post ads for five different jobs and his five jobs are guaranteed to be listed higher in a search result than similar jobs listed by a Subscriber with less than five Subscriptions. A Subscriber with a single Subscription can post an ad for one job and his job is guaranteed to be listed above the jobs listings on third party sites by non-Subscribers, which have been aggregated and index by the Company's computers using meta search technology.
   c. For example, if a visitor to the Company's website is interested in an accounting job in New York City, with a base salary not less than $65,000 per year, he visits the Jackpot Marketplace Jobs webpage and under Jobs Search enters a search criteria of: type of job desired “accounting”, city “New York City”, salary range “$50,000-$100,000”. The Company's computers search and index all of the accounting jobs in New York City with an annual salary range of $50,000-$100,000 posted by its Subscribers in descending order, with the Subscribers with the most Subscriptions being listed first. At the same time, the Company's computer utilize meta search technology to aggregate and index all of the accounting jobs in New York City with an annual salary range of $50,000-$100,000 posted at various online jobs' sites, e.g., Monster.com, HotJobs.com, Carrerbuilder.com, Indeed.com, NYTimes.com, etc. If the Subscriber sees a job opening that interests him that is listed by another Rewards Program Subscriber, he clicks on the listing and it opens a complete listing of the job requirements that is hosted on the Company's computers. If the Subscriber sees a job opening that interests him that is listed by another job listing site like Monster.com, he clicks on the listing and it takes him to the Monster.com website where he can view a complete listing of the job requirements.
4. The Personals section (555). Subscribers can create, post, and search Personals profiles at no additional expense beyond the Rewards Program Subscription fee.
   d. Subscribers are entitled to one Personals ad at a time per Subscription at no additional expense above the Rewards Program Subscription fee. Purchasing multiple Subscriptions for any purpose provides the Subscriber's personals ad priority placement in search results, which has the potential of dramatically increasing the number of viewers that see their personals listing.
   e. For example, a Subscriber who purchases ten Subscriptions is able to post ten different classified ads in any of the five major categories and if one of those listings is a personals ad, their personal ad is guaranteed to be listed higher in an applicable search result than similar personal ads listed by a Subscriber with less than ten Subscriptions.
5. The Classified section (560). The Jackpot Marketplace includes a general Classified section (560) where Subscribers can place classified ads for virtually anything that can be legally bought and sold.
   f. Subscribers are entitled to one classified ad at a time per Subscription at no additional expense above the Rewards Program Subscription fee. Subscribers who wish to maintain multiple classified ad listings at the same time can do so by purchasing multiple Subscriptions. Purchasing multiple Subscriptions also provides the seller priority placement in applicable search results which has the potential of dramatically increasing the number of potential buyers that see his listings.
   g. For example, a Subscriber who purchases ten Subscriptions is able to post ten different ads for books, jewelry, electronics, bikes, musical instruments, tickets to a sporting event, etc. and his ten listings are guaranteed to be listed higher in a search result than similar listings by Subscribers with less than ten Subscriptions. A Subscriber with five Subscriptions is able to post ads for five different items and their five ads are guaranteed to be listed higher in a search result than similar cars listed by a Subscriber with less than five Subscriptions. A Subscriber with a single Subscription can post an ad for one item and his item is guaranteed to be listed above a similar listing posted on third party sites by non-Subscribers that have been aggregated and index by the Company's computers using meta search technology.

Jackpot Shopping

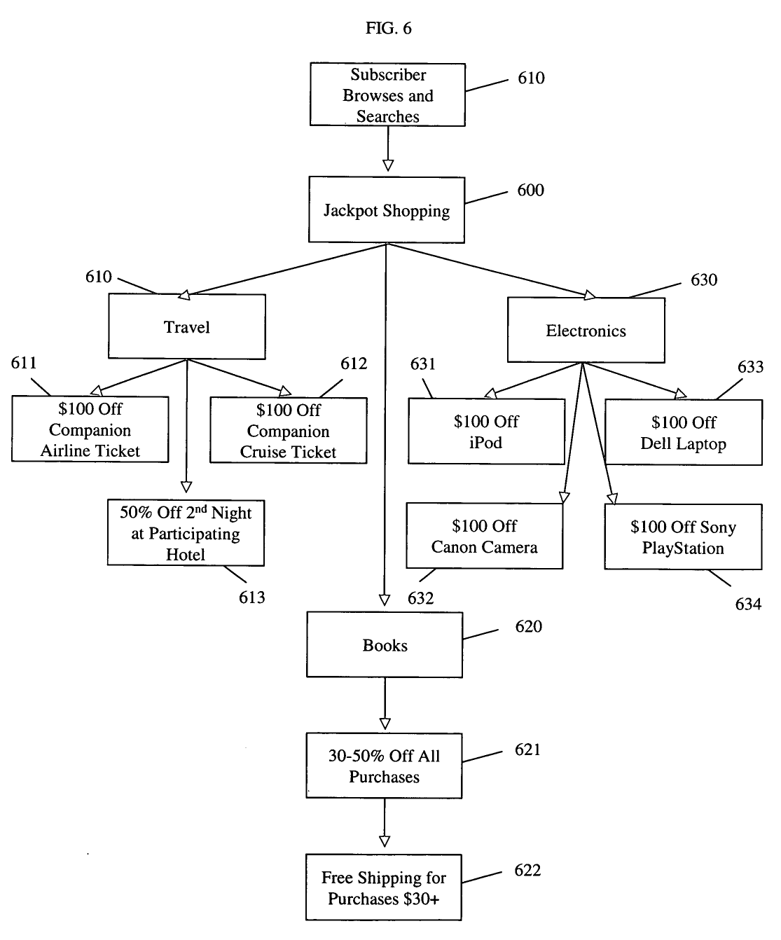

FIG. 6 illustrates the Jackpot Shopping part of the program. Jackpot Shopping (600) is a site that offers special deals and discounts on goods and services to Subscribers. The Company's computer updates and index the deals and discounts regularly and makes them available exclusively to Rewards Program Subscribers. In addition to the special deals and discounts that will be available exclusively for Subscribers, the Company's computer utilize meta search technology (described above) to aggregate and index on the Jackpot Shopping webpage millions of deals and discounts available from online retailers and brick and mortar retailers located in and around the Subscriber's zip code.

Subscribers to the Rewards Program can browse and search Jackpot Shopping for items and services of interest (610), and can purchase good and services as desired from the Company and Partner Companies. Examples of goods and services available at Jackpot Shopping include:
Travel (610). Subscribers receive $100 off of a companion airline ticket with purchase of a regular airfare on the Jackpot Shopping website (611). Subscribers receive $100 off of a companion cruise ticket with purchase of a regular cruise fare on the Jackpot Shopping website (612). Subscribers receive 50% off the price of a hotel room for a second night stay reserved on the Jackpot Shopping website (613).
Books (620). Subscribers get between 30% and 50% off of all books purchased on the Jackpot Shopping website (621), and also get free shipping on all book purchases that exceed $30 after discount (622).
Electronics (630). Subscribers get $100 off of purchases of Apple iPods (631), Canon Digital Cameras (632), Dell Laptops (633), and Sony PlayStations (634) purchased on the Jackpot Shopping website. “Cha-Ching” Live Rewards Updates

“Cha-Ching” Live Rewards Updates is an instant notification tool that brings updates of especially generous deals and discounts to the desktops or e-mail boxes of Rewards Program Subscribers.

Subscribers have the option of having Live Rewards Updates delivered to their e-mail box, desktop computer, laptop computer, or other suitable device they utilize to access the Internet, such as a PDA. If a Subscriber chooses to have Live Rewards Updates delivered to his e-mail box, he logs into Subscriber account and clicks the icon on the Company's website requesting that Live Rewards Updates be delivered via e-mail. The Company's computers then add the Subscriber's e-mail address, which is also the Subscriber's login, to the database of Subscribers who wish to receive Live Rewards Updates via e-mail.

If a Subscriber chooses to have Live Rewards Updates delivered directly to his desktop, laptop or other device, he logs into his Subscriber account and clicks the icon on the Company's website requesting that Live Rewards Updates be delivered directly to his desktop. The Company's computers then provide a download that the Subscriber approves to be installed onto their desktop, laptop or other device. The download provides an executable to be installed on their computer, of which the functionality will be controlled by the Company through future releases. The download provides a Live Rewards Update icon for the Subscribers' desktop, and an icon for his utility bar that highlights and sounds the “Cha-Ching” sound each time a Live Rewards Update is activated. The download also embeds a command string in the start-up sequence of the Subscriber's computer, which starts up and maintains an active Internet connection on the Subscriber's desktop with the Company's computers that enables the Company to push content to the Subscriber whenever the Subscriber's computer is on. Thus based upon the flash of the icon and the “Cha-Ching” sound, the Subscriber is alerted of any fresh content in the Live Rewards Update window.

If a Subscriber chooses to have Live Rewards Updates delivered directly to their desktop and their e-mail box, he logs into his Subscriber account and clicks the icon on the Company's website requesting that Live Rewards Updates be delivered directly to his desktop and e-mail box. The Company's computer then performs the functions described above on behalf of the Subscriber.

When Partner Companies have excess inventory or wish to run a promotion, they can attempt to quickly sell their inventory or promote their products by having a Live Rewards Updates sent out by the Company to the desktops or e-mail boxes of Subscribers. The Partner Company notifies the Company that it wishes to offer a particularly generous deal or discount to Jackpot Subscribers. If the Company determines that the product or service being offered by the Partner Company is of particular interest or value to all or some of its Subscribers, then the Company's computers send, via e-mail or the active Internet connection on the Subscribers' desktop, a Live Rewards Update of the deal or discount to the desktop or e-mail box of some or all of its Subscribers. When the deal reaches the Subscriber's desktop or when the Subscriber opens their e-mail, Live Rewards Update audibly notifies the Subscriber that a special deal or discount is available by making the “Cha-Ching” sound that a cash register makes when it is opened. A pop-up window also notifies the Subscriber of the deal or discount.

Subscribers are encouraged to create a customer profile for themselves and their family members. When special deals and discounts become available that match their profile, they are notified via e-mail or the active Internet connection on their desktops that there are special deals or discounts available that may be of interest to them. The more accurate the profile, the better the Live Rewards Update serves the Subscriber.

The Company's computers identify Subscribers who have multiple Subscriptions, and give them priority notification. The more Subscriptions a Subscriber purchases, the sooner the Company's computers notify them about the best deals and discounts that meet their profile, thereby giving them the best opportunity to take advantage of the special deals or discounts.

Jackpot Coupons

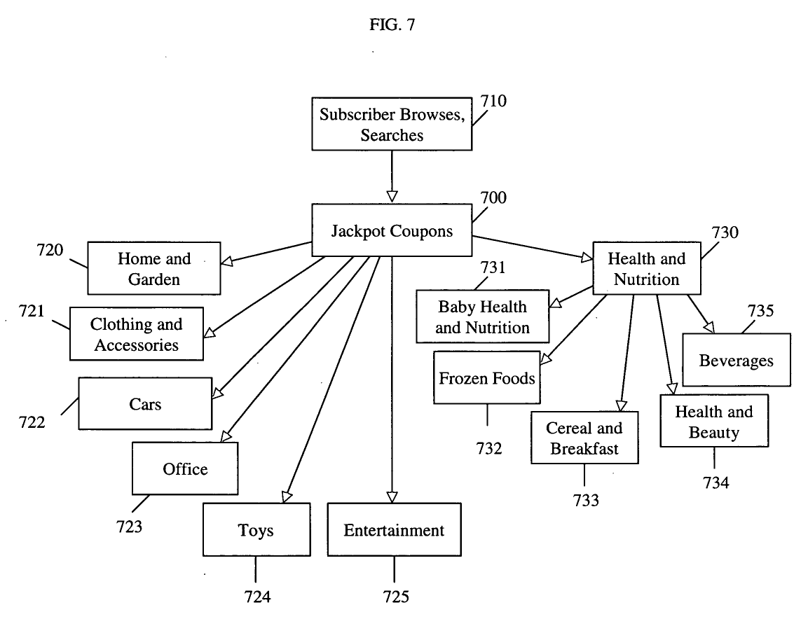

FIG. 7 illustrates the Jackpot Coupons part of the program. In 2003, approximately 258 billion coupons were distributed in the United States, making it a popular way to reward customers. Jackpot Coupons offers a more efficient and cost-effective way of distributing coupons.

Jackpot Coupons (700) is a site that features over $200 worth of coupons and special discounts available exclusively to Rewards Program Subscribers. The Company updates the coupons and special discounts three times a week and makes them available online at the Company's website. The Company informs Subscribers of coupon and discount updates via the online Newsletter, which is distributed three times a week, and which contains a link to the Jackpot Coupons website. Subscribers to the Rewards Program can browse and search Jackpot Coupons for coupons for goods and services of interest to the Subscriber (710). Jackpot Coupons include printable coupons for participating “brick and mortar retailers” and online coupons redeemable online at the Company's website or the website of the Partner Company offering the discount. The coupons for brick and mortar retailers include a bar code that enables them to be printed by the Subscriber and easily scanned by participating retailers. The online coupons are electronic and can be redeemed online at the Company's website or at the website of the Partner Company offering the discount.

The coupons are separated into various categories, to help Subscribers easily browse for and find coupons of interest. The categories include: Home and Garden (720), Clothing and Accessories (721), Cars (722), Office (723), Toys (724), Entertainment (725), Health and Nutrition (730), and other categories that may be of interest to Subscribers. For convenience, the categories may have subcategories. Health and Nutrition has subcategories such as: Baby Health and Nutrition (731), Frozen Foods (732), Cereal and Breakfast (733), Health and Beauty (734), and Beverages (735).

Jackpot Credit Card

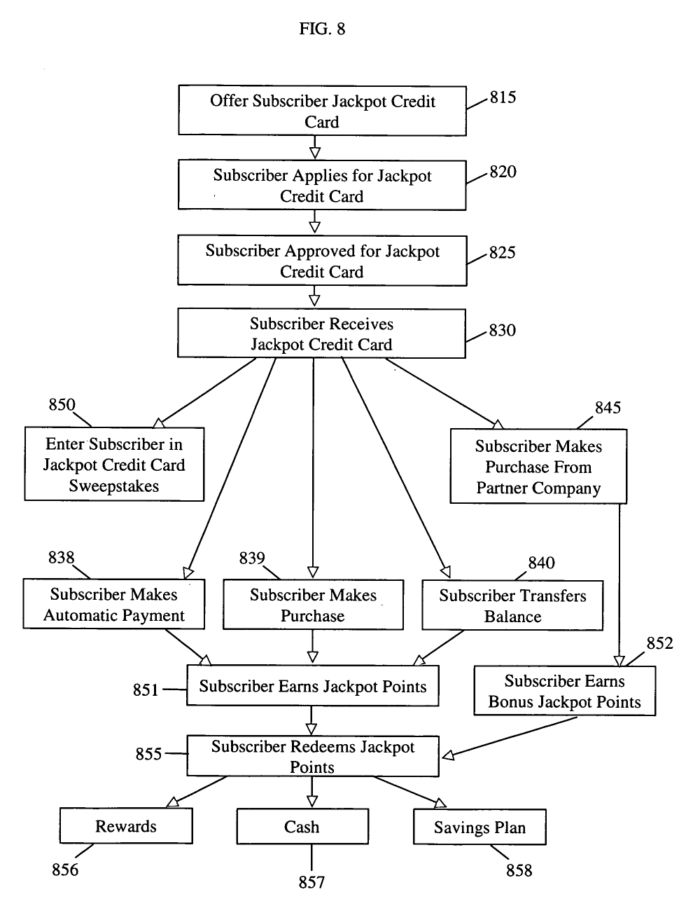

The Jackpot Credit Card is available exclusively to Rewards Program Subscribers, and is provided by a Partner Bank. FIG. 8 illustrates the Jackpot Credit Card part of the program. The Company and Partner Bank advertise and offer Subscribers the opportunity to apply for the Jackpot Credit Card, in order to increase the likelihood that Subscribers apply for the card (815). When a Subscriber purchases their Rewards Program Subscription, as described above, the Company informs him that he has an “exclusive” opportunity to apply for the Jackpot Credit Card, and offers him the opportunity to complete a Jackpot Credit Card application. Also, after the Subscriber purchases the Rewards Program Subscription, the Company's computers automatically sends him a welcome email highlighting benefits of the Jackpot Credit Card, and provides a link to an online card application. The Company's computers also send the Subscriber a welcome letter regarding his Rewards Program Subscription, highlighting benefits of the Jackpot Credit Card, including an application for the card, and noting a toll-free number that the Subscriber can call to apply (e.g., 1-888-JACKPOT). The Company's computers also, when appropriate, send a pre-approved application to the Subscriber. The Newsletters also include prominently placed advertisements about the Jackpot Credit Card and testimonials from cardholders who have won the Jackpot Credit Card Sweepstakes.

The Company's computers identify Subscribers who have not obtained a Jackpot Credit Card and send them e-mails about new ways to earn Jackpot Points when using the card, and notices regarding new companies participating in the Jackpot Points Rewards Program. These e-mails include a link to an online Jackpot Credit Card application. As mentioned above, the Rewards Program website contains a link to Jackpot Credit Card information and the opportunity to apply, as well as promotions for the card, associated rewards, the Jackpot Credit Card Sweepstakes, and the Jackpot Accelerated Rewards Sweepstakes. To summarize, the Company and Partner Bank use a wide variety of techniques to attract Subscribers' attention to the credit card.

If a Subscriber wants to apply for the Jackpot Credit Card, he does so by calling the Company's toll-free number, by clicking on a link to the credit card application on the Company's website or in the Newsletter, or by completing an application he receives in the mail (820). When the Subscriber purchased his Rewards Program Subscription, he provided much of the information needed for the credit card application. Thus, to apply for the Jackpot Credit Card, the Subscriber need only supply any additional information needed to complete a Credit Card application, such as his social security number, current annual household income, and his authorization for the Company to conduct a credit check.

Using the information the Subscriber provides, the Company or Partner Bank runs a credit check on the Subscriber to determine whether to approve the Subscriber for a Credit Card. If the Subscriber meets the credit requirements for a Jackpot Credit Card, the Partner Bank approves the Subscriber for the Jackpot Credit Card (825). The Partner Bank then utilizes the information the Subscriber provided in his credit card application to create a credit card account for the Subscriber, and sends the Subscriber a Jackpot Credit Card (830). The card comes with a description of its benefits and rewards, as well as instructions to dial a toll-free number to activate the card, e.g., 1-888-JACKPOT.

The Jackpot Credit Card directly integrates many rewards and benefits, enabling cardholders to automatically and discreetly receive awards and special discounts without presenting coupons or a discount card. The Company regularly informs the Subscriber of updates to the benefits and rewards accompanying the Jackpot Credit Card, and the results of the Jackpot Credit Card Sweepstakes and the Jackpot Accelerated Rewards Sweepstakes. For example, the morning after each Sweepstakes drawing the Company sends Subscribers with winning numbers e-mails with their winning numbers, a description of their prizes, e.g., Jackpot Points, and the total number of prizes they have accrued.

Jackpot Credit Card rewards and benefits include:

The Jackpot Points Rewards Program. For every dollar of purchases the Subscriber makes with the Jackpot Credit Card (839), he receives one Jackpot Point (851). Each Jackpot Point has a cash value of $0.01 and can be redeemed (855) for cash (857); for a variety of rewards (856) such as airline tickets, merchandise, and gift cards; or for cash equivalents such as a 529 Education Savings Plan (858). Cash redemption values start at 1,000 Jackpot Points.

The Subscriber also earns Jackpot Points for transferring balances (840), for example earning 10 Jackpot Points for each $100 of balances he transfers from another credit card to the Jackpot Credit Card. This is a one-time offer per credit card.

The Subscriber also earns Jackpot Points for making automatic payments to the Jackpot Credit Card (838). For example, the Subscriber earns 50 Jackpot Points per billing cycle when he uses automatic payment to pay, on time, at least the minimum payment due on his Jackpot Credit Card.

The Company's computers regularly send emails to the Subscriber to notify him of the total number of Jackpot Points in his account. The Jackpot Points e-mails contain advertisements and links to sites where the Subscriber can immediately use his Jackpot Points to purchase additional Subscriptions or other goods and services available on the Jackpot Shopping site. Subscribers are also sent e-mails about new ways to earn Jackpot Points by using the Jackpot Credit Card and notices concerning new companies participating in the Jackpot Accelerated Rewards Program.

The Jackpot Accelerated Rewards Program. The Company automatically enrolls the Subscriber using the Jackpot Credit Card in the Accelerated Rewards Program. Each time the Subscriber makes a purchase from a Partner Company using their Jackpot Credit Card (845), he automatically receives Jackpot Points at a higher rate (852), e.g., as much as 20 Jackpot Points per dollar spent. The Accelerated Rewards Program allows Partner Companies to directly market to Subscribers who are Jackpot Credit Cardholders, who in turn benefit from the increased number of Jackpot Points they earn. The Company and the Partner Bank benefit from increased use of the credit card.

The Subscriber also earns extra Jackpot Points when he uses his Jackpot Credit Card to, e.g., dine at participating restaurants, stay at participating hotels, or shop at participating retailers. The following are a few example rewards of the Jackpot Accelerated Rewards Program:
a) Earn three Jackpot Points for every dollar in purchases at participating retailers.
b) Earn six Jackpot Points for every dollar in purchases of selected brand name items at participating grocery stores and drug stores.
c) Earn three Jackpot Points for every dollar of car rentals during promotion periods. Subscribers who rent a car for three days get the fourth day free.
d) Earn 20 Jackpot Points for every dollar in accommodations at participating hotels or stay for three nights and get the fourth night free at participating hotels.

Integrating the Rewards Program into the Card. The Jackpot Accelerated Rewards Program integrates many of the rewards, specials deals and discounts associated with the Jackpot Rewards Program into the Jackpot Credit Card. This enables Reward Program Subscribers to automatically and discreetly receive rewards and special discounts when using their Jackpot Credit Card without presenting coupons or a discount card. Jackpot Cardholders are automatically enrolled in the Accelerated Rewards Program which offers offer generous Jackpot Points rewards for a wide variety of credit card transactions and Jackpot Cardholders are able to redeem their Jackpot Points for a variety of rewards including cash, airline tickets, merchandise, gift cards, or other cash equivalents including 529 Education Savings Plans.

The Jackpot Credit Card Sweepstakes. The Company automatically enters Subscribers who are Jackpot Credit Cardholders (Subscriber/Cardholder) for free into the Jackpot Credit Card Sweepstakes (850). Subscriber/Cardholders receive one free entry into each of the three times a week drawings for the Jackpot Credit Card Sweepstakes for as long as they remain a Subscriber to the Rewards Program and a Jackpot Cardholder.

When the Subscriber activates his Jackpot Rewards Credit Card, the Company's computers randomly assign the Subscriber/Cardholder a set of five white numbers out of a total of 65 white numbers and one red “JACKPOT” number out of a total of 65 red “JACKPOT” numbers. These selected numbers represent the Subscriber's entry in the current and all future Jackpot Credit Card Sweepstakes drawings, unless he changes his entry numbers online at the Company's website, cancels his Subscription, or cancels his Jackpot Credit Card.

The Company holds drawings for the Jackpot Credit Card Sweepstakes every Monday, Wednesday, and Friday at approximately 10:15 p.m. eastern time. The drawing involves drawing five white numbers out of a drum containing 65 white numbers and one red “JACKPOT” number out of a drum containing 65 red “JACKPOT” numbers.

Unlike the $1 Million to $5 Million Sweepstakes described above, instead of awarding a giant jackpot to contestants who exactly matches all 6 numbers, the Jackpot Credit Card Sweepstakes awards smaller prizes to Subscribers who match 1, 2, 3, 4, 5 or 6 numbers. This yields a much higher probability that Cardholder will win something during each Sweepstakes Drawing. The odds of winning something during a Jackpot Credit Card Sweepstakes drawing are 1 in 2.87.

The company awards prizes in Jackpot Points, e.g., 1 Jackpot Point for matching one number and 1,000,000 Jackpot Points for matching all 6 numbers. Each Jackpot Point has a cash equivalent of $0.01 and can be redeemed a variety of rewards including unlimited cash rewards, airline tickets, merchandise, gift cards, or other cash equivalents including 529 Education Savings Plans. Cash redemption levels start as low as 1,000 points or $10.

The Jackpot Accelerated Rewards Sweepstakes. The Subscriber/Cardholder is also automatically entered for free in the Jackpot Accelerated Rewards Sweepstakes each time he purchases a good or service offered through the Rewards Program using his Jackpot Credit Card. If the Subscriber/Cardholder uses his Jackpot Credit Card to purchase a good or service on the Jackpot Shopping site, e.g., goods and services offered by Partner Companies both online and at brick and mortar retail locations, the Company's computers automatically enter him for free in the Jackpot Accelerated Rewards Sweepstakes. A free entry into the Accelerated Rewards Sweepstakes is also stored in the bar code of Jackpot Coupons that are activated in the name of the Subscriber when he makes a purchase using the coupon and his Jackpot Credit Card.

The winning prize for the Jackpot Accelerated Rewards Sweepstakes is a $100,000 jackpot. At the end of each month, the Company's computers identify all of the free entries into the Jackpot Accelerated Rewards Sweepstakes that a Subscriber/Cardholder earned during the billing month. The Company's computers randomly assign the Subscriber/Cardholder a set of five white numbers out of 65 white numbers and one red “JACKPOT” number out of a 65 red “JACKPOT” numbers. These selected numbers represent the Subscriber/Cardholder's entry in the current Jackpot Accelerated Rewards Sweepstakes drawings, but expire after that drawing and do not apply to any additional drawings.

Drawings for the Jackpot Accelerated Rewards Sweepstakes are held on the fifteenth day of the month after the end of the billing month in which the Subscriber/Cardholder earned his free entry or entries in the Sweepstakes by using his Jackpot Credit Card. The odds of winning the Jackpot Accelerated Rewards Sweepstakes are determined by the total number of entries in the Sweepstakes at the time of the drawing.

After each Jackpot Accelerated Rewards Sweepstakes drawing, the Company's computers examine all the entries in a drawing; identify the entries with numbers that match some or all of the five white numbers and the one red “JACKPOT” number selected during the drawing; organize the entries according to their probability; and segregates the entry or entries with the lowest probability, e.g., the most matching numbers. Having identified one or more contestants whose entry matches a certain number of the winning numbers with the lowest probability, the Company either awards the $10,000 jackpot to a single winner or holds a second drawing, as set forth above, to determine the winner.

Obtaining Additional Reward Program Subscriptions For Free

Subscribers can obtain free Rewards Program Subscriptions and free entry into the $10,000 Sweepstakes and the $1 Million to $5 Million Sweepstakes by making “Subscription-like,” e.g., repeating, purchases of items and services from the Company or Partner Companies, such as:
1. Opening a checking, investment, retirement, or college savings account with a minimum initial balance of $2,500 with the Company's Partner Bank.
2. Purchasing a home mortgage loan, home equity loan, or opening a line of credit through the Company, Partner Company, or Partner Bank.
3. Financing a car or truck through the Company, Partner Company, or Partner Bank.
4. Purchasing home, automobile, life, health, business, supplemental or other forms of insurance through the Company or one of its Partner Companies.
5. Purchasing cable television, Internet, cellular telephone, or telephone service satellite radio, Internet radio, Internet television, e-mail, text messaging, instant messaging, or other communication services through the Company or one of its Partner Companies.
6. Purchasing anti-virus software or computer utility software through the Company or one of its Partner Companies, that automatically updates on the Subscribers computer with each Subscription renewal.
7. Purchasing a membership to a club or association (e.g., health club or automotive association) through the Company or one of its Partner Companies.
8. Purchasing a Subscription or membership for online educational services or online video game service for themselves or their children through the Company or one of its Partner Companies.
9. Purchasing a Subscription, membership, or other form of participation in online games or other games of skill through the Company or one of its Partner Companies
10. Purchasing magazine and newspaper Subscriptions through the Company or one of its Partner Companies.
11. Purchasing season tickets (e.g., sports, theatre, etc.) through the Company or one of its Partner Companies.
   Additionally, Companies that participate in the Rewards Program and have their credit card transactions processed by the Company or one of its Partner Companies receive an additional Subscription to the Rewards Program for free and are automatically entered for free into every Sweepstakes drawing. Companies that participate in the Rewards Program also receive free entries into the Partner Companies Sweepstakes every time a Jackpot Credit Card is used to purchase something from their company.

System for Automatically Renewing Subscriptions and Entering Subscribers into Sweepstakes

In general, one or more computers can be programmed to perform the various components of the method described herein.

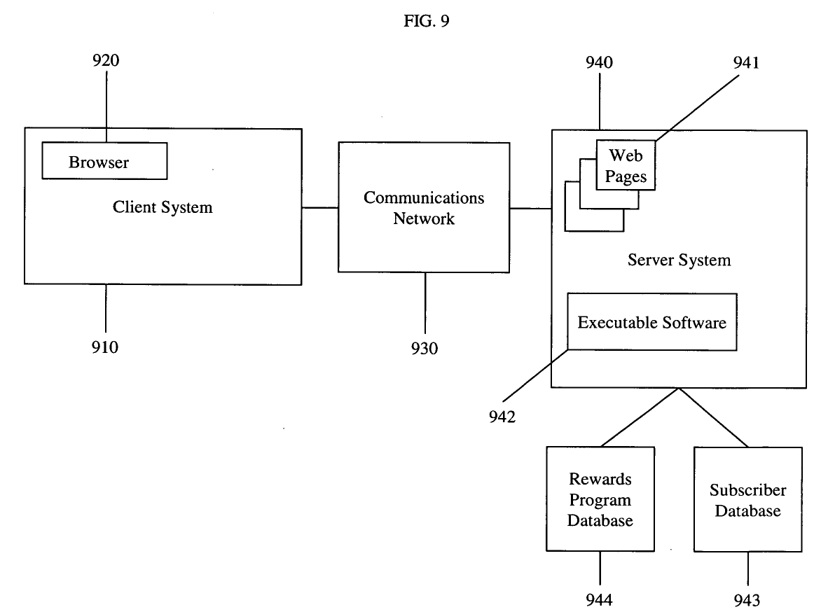

FIG. 9 shows a high level block diagram of a system on which the functions described herein can be implemented. Fundamentally, it includes a client computer 910 or other communications device at the Subscriber side of the connection, a server system 940 on the Company's side of the connection and a communications network 930 (e.g. the Internet) interconnecting the two systems.

The client system 910 includes software running on a computer that implements a browser 920 that provides the interface through which the Subscriber interacts with the server. The server system 940, in turn, implements through its software various web pages 941 that are displayed on the browser of the client's computer. The server system also includes executable software 942 that implements the functionality described above, including:
Automatically renewing the Subscriber's Subscription.
Automatically charging the Subscriber's credit or debit card to pay for the Subscription.
Maintaining a Subscriber database 943 that identifies all Subscribers and relevant information for those Subscribers.
Maintaining accounts that show the status of the Jackpot Credit Card for each Subscriber.
Maintaining an account for each Subscriber that tracks his Jackpot Points and other rewards he earns through participation in the program.
Maintaining a database of information 944 relating to the Rewards Program.
Maintaining various Marketplace web pages concerning, e.g., real estate, automobiles, jobs, personals, and classifieds.
Maintaining online shopping sites available exclusively to Subscribers.
Maintaining web pages with coupons and other special discounts available exclusively to Subscribers.
Automatically sending Subscribers Live Rewards Updates of special rewards and discounts available for a limited time.
Automatically sending each Subscriber an e-mail three times a week that contains an electronic Newsletter that when opened automatically takes the Subscriber to the Company's website.
Automatically entering Subscribers and companies into the appropriate sweepstakes.
Identifying winners in the sweepstakes.
Initiating processes for notifying those winners.
Automatically sending Subscribers sweepstakes results after each sweepstakes drawing.

Although the server is shown as a single entity, it can be a distributed system in which the functionality and the databases are spread among a number of separate computers and storage devices that are located at one location or multiple separate locations.

Variations of the Program

As described, the Subscriber subscribes to the program by calling the Company at Jackpot, or by visiting the Company website. In general, the Company can offer Subscription sales by any means that allow it to effectively market to potential Subscribers, and allow Subscribers to easily make the purchase. For example, the Company could send out solicitations in the mail, and Subscribers could purchase Subscriptions through mail order. Or, the Company could open retail outlets in popular locations, and Subscribers could “walk up” to purchase a Subscription. The Company could also solicit potential Subscribers by phone, enabling them to make an immediate sale to interested Subscribers.

The Company automatically charges Subscribers the Subscription fee by charging their credit card, charge card, debit card, phone bill or cell phone bill but can use any other method that enable Subscribers to be charged or billed on an ongoing basis e.g., cable television bill, Internet service bill, utility bill, billed by the Company automatic withdrawals or funds transfers from the Subscriber's bank account, electronic checks, checks by phone, and checks by fax, etc.

The Subscriber accesses many of the benefits and rewards of the Rewards Program using the Internet, but the Company can provide benefits and rewards in other ways. The Company can periodically mail printed coupons, shopping catalogs, and classified ads to the Subscriber, and the Subscriber responds over the phone, or by a mail-in form.

The jackpots for the various Sweepstakes are not by necessity limited to $10,000 and the range of $1 million to $5 million. The jackpot can be any value. The Company can operate the various Sweepstakes in other ways than the described six-ball drawing, so long the Sweepstakes are operated fairly and honestly and the winner or winners of the Sweepstakes are selected at random. The Company can also operate the Sweepstakes more or less frequently than three times per week, as it sees appropriate. Similarly, the Company can vary the period for renewing the Rewards Program subscription, and the payment plans for such, as it sees appropriate. Similarly, the times and days of the drawings, entry deadlines and other rules and characteristic for same, can be different than those described herein. Additionally, the Company can add a game of skill component to the Sweepstakes, as it sees appropriate.

The Company can also offer Subscriptions to a Rewards Program that differs from the described Rewards Program.

The Company can also offer Subscriptions to products or services besides the described Rewards Program. The Sweepstakes may attract a Subscriber to purchase a Subscription, however the Subscription itself should represent a “good value” to the Subscriber. The program applies to any possible products and services that can be sold as a subscription or “like a subscription” on an automatically renewing basis including but not limited to: other kinds of rewards programs, other kinds of subscriptions, media content (e.g., magazines, newspapers, books, pictures, music, videos, video games, etc.), financial services (e.g., checking, investment accounts, retirement accounts, mortgage, home equity loans, lines of credit, credit cards, gift cards, car or truck financing, insurance, etc.), financial transactions (buy and selling of stocks, commodities, etc.) services (e.g., cable television, Internet, telephone, VoIP, cellular, online video games, satellite radio, Internet radio, Internet television, calling cards, e-mail, text messaging, instant messaging, other communication services, security services, etc.), clubs (purchasing clubs, book clubs, travel clubs, auto clubs, etc.) renting or leasing (cars, trucks, computers, furniture, televisions, etc.), associations, memberships, season tickets, and participation in various games of skill and games of skill competitions both online (e.g. online poker, chess, etc.) and offline (poker, bowling, etc.), computer software and services (e.g., operating systems, anti-virus software, computer utility software, word processing software, data management software, financial management software, etc.), online interactive services (online video games, online educational services, etc.), charitable and cause-related activities (charitable donations, political donations, pay for prayers, pay to have a tree saplings planted, etc.)

Other embodiments are within the following claims.

What is claimed is:

1. A method comprising:
in response to a request, by a subscriber, for a subscription to a product or service, wherein said subscription has a subscription period and wherein the subscription period is initially for a first period of time:
(a) automatically providing the subscriber with the product or service for the first period of time;
(b) automatically entering the subscriber into one or more sweepstakes drawings which occur during said first period of time, said one or more sweepstakes drawings having one or more corresponding jackpots;
(c) at the end of the subscription period, automatically renewing the subscription for a next period of time;
(d) in connection with the renewed subscription, automatically entering the subscriber into one or more sweepstakes drawings which occur during the next period of time; and
(e) repeating operations (c) through (e) until the subscriber terminates the subscription.

2. The method of claim 1, further comprising receiving authorization from the subscriber to repeatedly automatically renew the subscription.

3. The method of claim 1, further comprising conditioning an eligibility of the Subscriber to be entered in the one or more sweepstakes drawings which occur during the subscription period on the repeated renewal of the subscription.

4. The method of claim 1, wherein there are multiple sweepstakes drawings during the subscription period

5. The method of claim 1, further comprising setting the jackpot for at least one sweepstakes drawing above a predetermined minimum amount.

6. The method of claim 5, further comprising, if said at least one sweepstakes drawing fails to produce a winner, rolling said jackpot for that sweepstakes drawing into the jackpot for a consecutive sweepstakes drawing.

7. The method of claim 6, further comprising limiting said jackpot for said at least one sweepstakes drawing to be less than or equal to a predetermined maximum amount.

8. The method of claim 7, further comprising, if said jackpot for said at least one sweepstakes drawing reaches the predetermined maximum amount and that sweepstakes drawing fails to produce a winner, conducting a second drawing to determine one or more winners of said jackpot.

9. The method of claim 8, wherein the second drawing comprises randomly selecting a number from 1-20 to determine the number of winners of said jackpot.

10. The method of claim 7, further comprising, if a predetermined date is reached and said jackpot for said at least one sweepstakes drawing has not reached the predetermined maximum amount, conducting additional drawings until there is a winner of said jackpot.

11. The method of claim 1, wherein the sweepstakes drawing comprises identifying multiple winning entries, treating these entries as finalists, and holding a second drawing to determine a single winner.

12. The method of claim 1, further comprising requiring the subscriber to pay for the subscription by way of an automatic payment method.

13. The method of claim 12, wherein the automatic payment method involves one of a credit card, charge card, debit card, a charge to a phone bill, and an automatic withdrawal from a bank account.

14. The method of claim 1, wherein said product or service is a rewards program.

15. The method of claim 14, wherein providing the subscriber with said product or service comprises enrolling the subscriber in the rewards program.

16. The method of claim 14, wherein said rewards program comprises at least one partner company offering at least one of a discount on an item or service, a benefit, or deal to the subscriber.

17. The method of claim 16, further comprising rewarding the partner company based on the value of the discount, benefit, or deal it provides to the subscriber

18. The method of claim 17, wherein the reward for the partner company includes at least one of advertising space, priority placement at the top of search results, and free entry into one or more sweepstakes.

19. The method of claim 15, wherein the rewards program includes at least one of a newsletter, an online marketplace, an online shopping area, an online coupons area, and an instant rewards notification tool.

20. The method of claim 19, wherein the online marketplace comprises classified ad listings.

21. The method of claim 20, wherein the subscriber is eligible to post a classified ad listing for free on the online marketplace.

22. The method of claim 21, wherein the classified ad listing of the subscriber receives a priority placement related to a number of subscriptions the subscriber holds.

23. The method of claim 19, wherein the online shopping area comprises discounted products or services offered for sale by at least one partner company.

24. The method of claim 19, further comprising sending the newsletter electronically to the subscriber.

25. The method of claim 24, wherein the newsletter contains an update to the rewards program.

26. The method of claim 25, wherein the newsletter contains a link to one or more online features of the rewards program.

27. The method of claim 19, wherein the online coupons area comprises at least one of a printable coupon to a brick and mortar retailer and an online coupon to an online retailer.

28. The method of claim 19, wherein the instant rewards notification tool electronically notifies the subscriber of a special deal or discount on a product or service offered for sale by a partner company.

29. The method of claim 28, wherein the subscriber receives priority notification of the special deal or discount related to a number of subscriptions the subscriber holds.

30. The method of claim 1, further comprising offering the subscriber an opportunity to apply for a specified credit card that is made available only to subscribers to the product or service.

31. The method of claim 30, further comprising, if the subscriber obtains the specified credit card, automatically entering the subscriber in a credit card sweepstakes.

32. The method of claim 31, further comprising, if the subscriber uses the credit card to purchase an item from a partner company, automatically entering the subscriber in at least one additional sweepstakes or automatically entering the subscriber an additional time in the credit card sweepstakes.

33. The method of claim 30, further comprising, if the subscriber obtains the specified credit card, automatically enrolling the subscriber in an accelerated rewards program that offers discounts at participating businesses.

34. The method of claim 1, wherein the subscriber receives rewards for purchasing multiple subscriptions.

35. The method of claim 1, wherein a percentage of gross profit from sale of the subscription is contributed to the jackpot

36. The method of claim 1, wherein said one or more sweepstakes drawings select a corresponding winner using a random number generation mechanism.

37. The method of claim 36, wherein said random number generation mechanism comprises a computerized random number generator.

38. An apparatus comprising:
a computer system; and
computer-readable media storing program code which when executed on the computer system performs the functions of:
in response to a request, by a subscriber, for a subscription to a product or service, wherein said subscription has a subscription period and wherein the subscription period is initially for a first period of time:
(a) automatically providing the subscriber with the product or service for the first period of time;
(b) automatically entering the subscriber into one or more sweepstakes drawings which occur during said first period of time, said one or more sweepstakes drawings having one or more corresponding jackpots;
(c) at the end of the subscription period, automatically renewing the subscription for a next period of time;
(d) in connection with the renewed subscription, automatically entering the subscriber one or more sweepstakes drawings which occur during the next period of time; and
(e) repeating operations (c) through (e) until the subscriber terminates the subscription.

39. A computer implemented method comprising:
(a) enrolling a subscriber in a subscription to a product or service, said subscription having a subscription period and wherein the subscription period is initially for a first period of time;
(b) in connection with the subscription, automatically entering the subscriber into one or more sweepstakes drawings which occur during the subscription period;
(c) at the end of the subscription period, automatically renewing the subscription for a next period of time;
(d) in connection with the renewed subscription, automatically entering the subscriber into one or more sweepstakes drawings which occur during the next time period; and
(e) repeating operations (c) through (e) until the subscriber terminates the subscription.
